(19) United States
(12) Patent Application Publication
(10) Pub. No.: US 2024/0390880 A1
(43) Pub. Date: Nov. 28, 2024

(54) CATALYTIC STRUCTURES WITH METAL OXIDE SUBSTRATES, AND METHODS FOR FABRICATION AND USE THEREOF

(71) Applicants: UNIVERSITY OF MARYLAND, COLLEGE PARK, College Park, MD (US); HIGHT-TECH, INC., College Park, MD (US); THE JOHNS HOPKINS UNIVERSITY, Baltimore, MD (US)

(72) Inventors: Liangbing HU, Rockville, MD (US); Tangyuan LI, College Park, MD (US); Robert GATTE, Elgin, SC (US); Chao WANG, Ellicott City, MD (US); Noah ZECHER-FREEMAN, Baltimore, MD (US)

(21) Appl. No.: 18/694,398

(22) PCT Filed: Sep. 23, 2022
(86) PCT No.: PCT/US22/44541

§ 371 Date: Mar. 21, 2024

Related U.S. Application Data
(60) Provisional application No. 63/261,557, filed on Sep. 23, 2021.

(51) Int. Cl. B01J 23/89; B01J 21/18; B01J 35/54; C01B 21/26; C01C 1/04

(52) U.S. Cl. CPC B01J 23/8993; B01J 21/18; B01J 23/894; B01J 35/54; C01B 21/262; C01B 21/265; C01C 1/0411

(57) ABSTRACT

A catalytic structure has a substrate and a plurality of high-entropy alloy (HEA) nanoparticles. At least a surface layer of the substrate is formed of a metal oxide. The HEA nanoparticles can be formed on the surface layer. Each HEA nanoparticle can comprise a homogeneous mixture of at least four different elements forming a single-phase solid-solution alloy. The catalytic structures can be used to catalyze a chemical reaction, such as an ammonia oxidation reaction, an ammonia synthesis reaction, or an ammonia decomposition reaction.

### CROSS-REFERENCE TO RELATED APPLICATION

The present application claims the benefit of U.S. Provisional Application No. 63/261,557, filed Sep. 23, 2021, entitled “Supported Multielement Nanoparticle Catalyst and Methods of Making and Using the Same,” which is incorporated by reference herein in its entirety.

### STATEMENT REGARDING FEDERALLY SPONSORED RESEARCH

This invention was made with government support under DEAR0001239 awarded by the Department of Energy (DOE), Advanced Research Projects Agency-Energy (ARPA-E). The government has certain rights in the invention.

### FIELD

The present disclosure relates generally to catalysts, and more particularly, to catalytic structures comprising high-entropy alloy (HEA) nanoparticles formed on and/or within metal oxide substrates.

### BACKGROUND

In conventional supported catalysts, metal catalysts are distributed over a porous solid substrate. The synthesis of supported catalysts typically involves impregnation, drying, and calcination. Conventional supported catalysts have been limited to unary, binary, or ternary components, primarily due to the calcination in a furnace (e.g., continuous heating at a temperature of ˜500-600° C. for hours) to decompose the metal precursor. However, such heating techniques make it difficult to produce high-entropy alloy (HEA) nanoparticles. In particular, due to the high temperature and the long duration in conventional furnaces, the metal can react with the substrate to form impurities or second phases, thereby affecting the formation and dispersion of high-quality metal on the nano-scale level. Embodiments of the disclosed subject matter may address one or more of the above-noted problems and disadvantages, among other things.

### SUMMARY

Embodiments of the disclosed subject matter system provide catalytic structures, each comprising a plurality of high-entropy alloy (HEA) nanoparticles formed on and supported by a substrate, as well as methods for fabrication and use thereof. In some embodiments, at least part of the substrate is formed of a metal oxide, such as, but not limited to, aluminum oxide, titanium oxide, cerium oxide, silicon oxide, zeolite, spinel, or perovskite. In some embodiments, each HEA nanoparticle may be formed of at least five elements that can be used to catalyze an ammonia oxidation reaction, an ammonia synthesis reaction, or an ammonia decomposition reaction. For example, a catalytic structure having HEA nanoparticles formed of platinum, palladium, rhodium, cobalt, and a rare-earth element can be used in an ammonia oxidation reaction, and/or a catalytic structure having HEA nanoparticles formed of cobalt, molybdenum, iron, nickel, and copper or manganese can be used in an ammonia synthesis reaction.

In one or more embodiments, a catalytic structure comprises a substrate and a plurality of high-entropy alloy (HEA) nanoparticles. At least a surface layer of the substrate can be formed of a metal oxide. The plurality of HEA nanoparticles can be formed on the surface layer of the substrate. Each HEA nanoparticle can have a maximum cross-sectional dimension less than or equal to 1 μm. Each HEA nanoparticle can comprise a homogeneous mixture of at least four different elements forming a single-phase solid-solution alloy.

In one or more embodiments, a method can comprise providing one or more catalytic structures. Each catalytic structure can comprise a substrate and a plurality of HEA nanoparticles. At least a surface layer of the substrate can be formed of a metal oxide. The plurality of HEA nanoparticles can be formed on the surface layer of the substrate. Each HEA nanoparticle can have a maximum cross-sectional dimension less than or equal to 1 μm. Each HEA nanoparticle can comprise a homogeneous mixture of at least four elements forming a single-phase solid-solution alloy. The method can further comprise flowing one or more reactants into contact with the one or more catalytic substrates such that a chemical reaction converts the one or more reactants at a first temperature to one or more products.

In one or more embodiments a method for fabricating a catalytic structure can comprise coating a substrate with a solution comprising a plurality of precursor metal salts. The plurality of precursor metal salts can comprise at least four different elements. At least a surface layer of the substrate can be formed of a metal oxide. The method can further comprise drying the substrate with the plurality of precursor metal salts. The method can also comprise subjecting the dried substrate to a thermal shock so as to form the catalytic structure. The thermal shock can comprise exposure to a peak temperature of at least 1500 K for a duration of 1 second or less. After the thermal shock, the catalytic structure can comprise a plurality of HEA nanoparticles formed on the surface layer of the substrate. Each HEA nanoparticle can have a maximum cross-sectional dimension less than or equal to 1 μm and can comprise a homogeneous mixture of at least four different elements forming a single-phase solid-solution alloy.

In one or more embodiments, a method can comprise removing a Pt-based catalyst and an N₂O-removal catalyst from a nitric acid production reactor. The nitric acid production reactor can have (i) one or more inlets for ammonia, oxygen, and nitrogen, and (ii) one or more outlets for NOₓ products. The Pt-based catalyst can be at a first location between the one or more inlets and one or more outlets prior to the removing. The N₂O-removal catalyst can be at a second location downstream of the first location prior to the removing. The method can further comprise installing one or more catalytic structures in the nitric acid production reactor. Each catalytic structure can comprise a substrate and a plurality of HEA nanoparticles. At least a surface layer of the substrate can be formed of a non-conductive metal oxide. The plurality of HEA nanoparticles can be formed on the surface layer of the substrate. Each HEA nanoparticle can have a maximum cross-sectional dimension less than or equal to 1 μm. Each HEA nanoparticle can comprise a homogeneous mixture of at least four elements forming a single-phase solid-solution alloy.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1A is a simplified schematic diagram illustrating aspects of a high-entropy alloy (HEA) nanoparticle, according to one or more embodiments of the disclosed subject matter.

FIG. 1B is a simplified schematic diagram of a catalytic structure comprising HEA nanoparticles formed on a metal oxide substrate, according to one or more embodiments of the disclosed subject matter.

FIGS. 1C-1D are macroscopic and microscopic images, respectively, of fabricated catalytic structures employing extruded aluminum oxide substrates, according to one or more embodiments of the disclosed subject matter.

FIG. 1E is a simplified schematic diagram of a catalytic structure comprising HEA nanoparticles formed on a metal-oxide-coated substrate, according to one or more embodiments of the disclosed subject matter.

FIG. 1F is a microscopic image of a fabricated catalytic structure employing an aluminum-oxide-coated carbon nanofiber substrate, according to one or more embodiments of the disclosed subject matter.

FIG. 2A is a simplified schematic diagram of HEA nanoparticles formed on a metal-oxide surface of a substrate, according to one or more embodiments of the disclosed subject matter.

FIG. 2B shows transmission electron microscopy (TEM) elemental mappings of an interface between fabricated HEA nanoparticles (PtPdRhCoCe) and an aluminum-oxide substrate, according to one or more embodiments of the disclosed subject matter.

FIG. 2C is a simplified schematic diagram of HEA and other nanoparticles formed on a metal-oxide surface of a substrate, according to one or more embodiments of the disclosed subject matter.

FIG. 2D shows TEM elemental mappings of HEA (PtPdRhCoCe) and other nanoparticles formed on an aluminum-oxide substrate, according to one or more embodiments of the disclosed subject matter.

FIG. 2E shows TEM elemental mappings of HEA (PtPdCoNiFe) nanoparticles formed on a carbon nanofiber substrate.

FIG. 2F is a simplified schematic diagram of a cross-sectional view of a metal oxide substrate, illustrating a gradient distribution of formed HEA nanoparticles, according to one or more embodiments of the disclosed subject matter.

FIG. 2G shows scanning electron microscopy (SEM) images of surface and cross-sectional portions of an aluminum-oxide substrate with a gradient distribution of HEA nanoparticles.

FIG. 3A is a simplified schematic diagram of various stages for fabricating catalytic structures, according to one or more embodiments of the disclosed subject matter.

FIG. 3B is a simplified schematic diagram of an enclosed thermal shock setup for fabricating catalytic structures, according to one or more embodiments of the disclosed subject matter.

FIG. 3C is a simplified schematic diagram of an open thermal shock setup for fabricating catalytic structures, according to one or more embodiments of the disclosed subject matter.

FIGS. 3D-3E illustrate alternative heater configurations for a thermal shock setup for fabricating catalytic structures, according to one or more embodiments of the disclosed subject matter.

FIG. 3F depicts a generalized example of a computing environment in which the disclosed technologies may be implemented

FIG. 4A is a process flow diagram of a method for fabricating catalytic structures, according to one or more embodiments of the disclosed subject matter.

FIG. 4B is a graph of an exemplary temperature profile of a thermal shock for forming HEA nanoparticles on a substrate, according to one or more embodiments of the disclosed subject matter.

FIG. 5 is a process flow diagram of a generalized method for use of catalytic structures in a chemical reaction, according to one or more embodiments of the disclosed subject matter.

FIG. 6A illustrates an exemplary ammonia oxidation reaction, according to one or more embodiments of the disclosed subject matter.

FIG. 6B illustrates retrofitting of an existing nitric acid production reactor to include catalytic structures with HEA nanoparticles, according to one or more embodiments of the disclosed subject matter.

FIG. 6C is a process flow diagram of a method for retrofitting of an existing nitric acid production reactor, according to one or more embodiments of the disclosed subject matter.

FIG. 7 illustrates an exemplary ammonia synthesis reaction, according to one or more embodiments of the disclosed subject matter.

FIG. 8A is a graph of product selectivity versus reaction temperature obtained from an ammonia oxidation reaction employing catalytic structures.

FIG. 8B is a graph of product selectivity and ammonia conversion versus time on stream for an ammonia oxidation reaction employing catalytic structures.

FIG. 8C is a graph of mass-dependent catalytic performance of powder and bulk forms of catalytic structures.

FIG. 9A is a graph of temperature-dependent catalytic activity of Co₂₅Mo₄₅-HEA nanoparticles on aluminum-oxide-coated carbon paper in an ammonia synthesis reaction operated at 10 bar and 50 standard cubic centimeters per minute (sccm) reactant gas flow.

FIG. 9B is a graph of temperature-dependent catalytic activity of Co₂₅Mo₄₅-HEA nanoparticles on extruded aluminum oxide substrates in an ammonia synthesis reaction operated at 10 bar and 50 sccm reactant gas flow.

FIG. 9C is a graph of temperature-dependent catalytic activity of the powder form of Co₂₅Mo₄₅-HEA nanoparticles on aluminum oxide substrate in an ammonia synthesis reaction operated at 10 bar and 50 sccm reactant gas flow.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about” is recited. Whenever “substantially.” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner.” “outer.” “upper.” “lower.” “top.” “bottom,” “interior.” “exterior.” “left,” right.” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following is provided to facilitate the description of various aspects of the disclosed subject matter and to guide those skilled in the art in the practice of the disclosed subject matter.

Thermal shock: Application of a thermal shock temperature for a time period having a duration less than or equal to about 1 second. In some embodiments, the duration of the time period of thermal shock temperature application is less than 500 milliseconds, for example, less than or equal to 100 milliseconds. For example, in some embodiments, the duration of the thermal shock can be in a range of about 1 microsecond to about 100 milliseconds, inclusive, for example, about 55 milliseconds. In some embodiments, the thermal shock may involve heating to the thermal shock temperature at a ramp rate of at least 10³ K/s (e.g., about 10⁵ K/s) prior to the heating time period, and/or cooling from the thermal shock temperature at a ramp rate of at least 10³ K/s (e.g., about 10⁵ K/s).

Thermal shock temperature: A peak or maximum temperature at a surface of one or more heating elements when energized (e.g., by application of a current pulse) and/or at a surface of a material being heated. In some embodiments, the thermal shock temperature is at least about 1500K, for example, in a range of about 1500 K to about 2500 K, inclusive (e.g., 1700-2300 K, inclusive). In some embodiments, a temperature at a material being heated (e.g., precursors on a substrate) within the furnace can match or substantially match (e.g., within 10%) the temperature of the heating element.

Particle size: A maximum cross-sectional dimension (e.g., diameter) of one or more particles. In some embodiments, an identified particle size represents an average particle size for all particles (e.g., an average of the maximum cross-sectional dimensions). In some embodiments, the particle size can be measured according to one or more known standards, such as, but not limited to, ASTM B214-16 entitled “Standard Test Method for Sieve Analysis of Metal Powders,” ASTM B330-20 entitled “Standard Test Methods for Estimating Average Particle Size of Metal Powders and Related Compounds Using Air Permeability.” ASTM B822-20 entitled “Standard Test Method for Particle Size Distribution of Metal Powders and Related Compounds by Light Scattering.” and ASTM B922-20 entitled “Standard Test Method for Metal Powder Specific Surface Area by Physical Adsorption.” all of which are incorporated by reference herein.

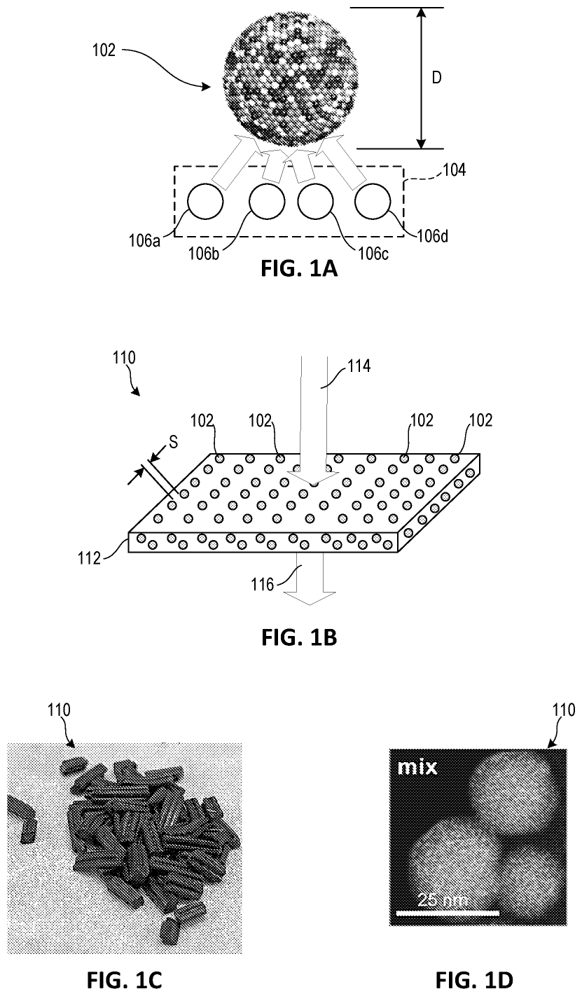

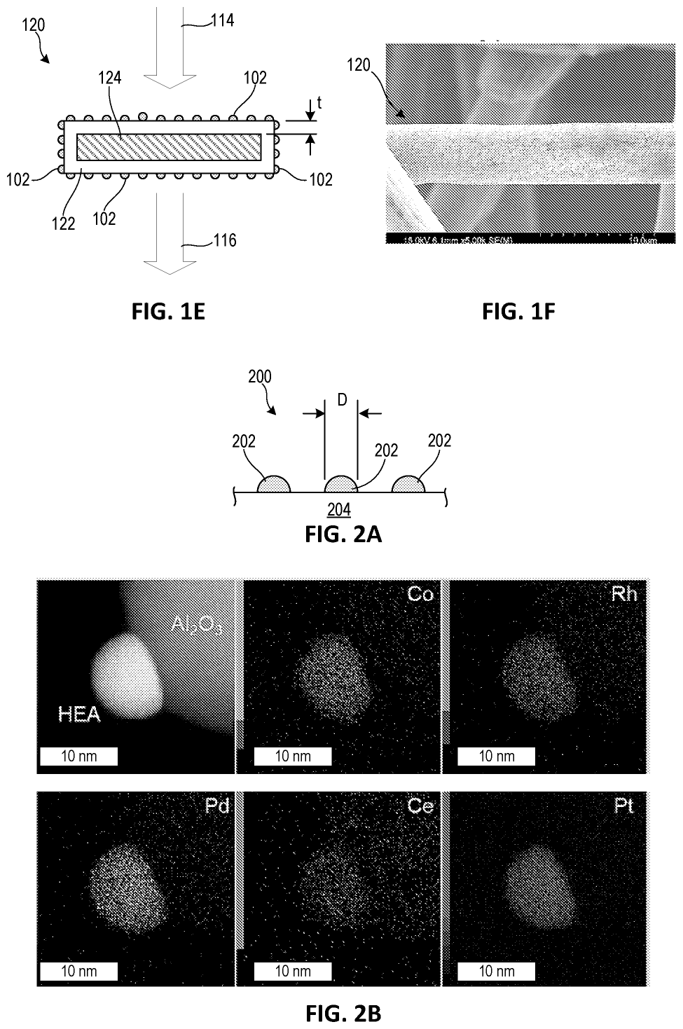

Nanoparticle: An engineered particle formed of a plurality of elements (e.g., at least four (4) elements, at least five (5) elements, or at least eight (8) elements) and having a maximum cross-sectional dimension (e.g., diameter when the particle is spherical, such as D in FIG. 1A less than or equal to about 1 μm, for example, about 100 nm or less. In some embodiments, each nanoparticle has a maximum cross-sectional dimension of less than or equal to about 25 nm, for example, in a range of 1-20 nm, inclusive.

High-entropy Alloy (HEA) nanoparticle: A nanoparticle comprising a homogeneous mixture of at least four elements that form a single-phase solid solution.

Non-HEA particles: A particle (e.g., nanoparticle or smaller) composed of three or less elements, for example, a single element particle (e.g., atom) or a binary element particle. In some embodiments, non-HEA particles simultaneously formed on a common substrate with HEA nanoparticles may have a particle size less than that of the HEA nanoparticles (e.g., ≤25% of the diameter of the HEA nanoparticles).

Noble Metal: Gold (Au), platinum (Pt), and other platinum-group metals, which includes iridium (Ir), osmium (Os), palladium (Pd), rhodium (Rh), and ruthenium (Ru).

Rare-earth Element: Any element selected from scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

Transition Metal: Any element selected from scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), lanthanum (La), hafnium (Hf), tantalum (Ta), tungsten (W), rhenium (Re), osmium (Os), iridium (Ir), platinum (Pt), gold (Au), mercury (Hg), actinium (Ac), rutherfordium (Rf), dubnium (Db), seaborgium (Sg), bohrium (Bh), hassium (Hs), meitnerium (Mt), darmstadtium (Ds), roentgenium (Rg), and copernicium (Cn).

### Introduction

High-entropy alloy (HEA) nanoparticles can be formed on a porous substrate to form a catalytic structure. The HEA nanoparticles can be formed of a homogeneous mixture of at least four elements (e.g., five or more) in a single solid-solution phase. The large number of elements (e.g., twenty possible transition and/or main-group metals) available for inclusion in the HEA nanoparticle can allow for tuning and/or optimization of the material composition and/or surface properties, for example, to maximize, or at least improve, catalytic activity, durability, or any other desirable characteristic. In some embodiments, the HEA nanoparticles also possess large mixing entropy that lowers the chemical potential for dealloying (ΔGₘᵢₓ=ΔHₘᵢₓ−T*ΔSₘᵢₓ). Alternatively or additionally, the HEA nanoparticles can exhibit highly distorted lattices that can reduce or inhibit atomic diffusion, which can give rise to enhanced thermodynamic stability and kinetic stability as compared to pure metals or simple alloys.

Such features may allow for high catalytic activity and durability, which may be particularly advantageous for catalytic applications in harsh reactions conditions, such as ammonia reactions and/or exhaust conversion. For example, catalytic structures according to embodiments of the disclosed subject matter can be used in thermochemical or thermocatalytic reactions, such as but not limited to ammonia (NH₃) synthesis, ammonia oxidation, ammonia decomposition, and/or NOₓ reduction (e.g., de-NOₓ).

In some embodiments, the substrate is a non-conductive solid metal oxide or has an outermost non-conductive metal oxide layer upon which the HEA nanoparticles are formed. For example, the metal oxide can be aluminum oxide, titanium oxide, cerium oxide, silicon oxide, zeolite, spinel, and/or perovskite. In some embodiments, a catalytic structure comprising a plurality of HEA nanoparticles on a substrate can have a low noble metal content, for example, less than or equal to 30 wt % of the catalytic structure (e.g., in a range of 2-10 wt %). For example, HEA catalysts supported on a metal-oxide substrate (e.g., alumina extrudate) may have less than 5 wt % of noble metals, which represents a greater than 20-fold reduction of precious metal content as compared to conventional platinum-rhodium gauze catalysts employed in ammonia oxidation.

### Catalytic Structures

Referring to FIG. 1A, a simplified illustration of an HEA nanoparticle 102 is shown. The nanoparticle 102 can be formed of a plurality 104 of elements, for example, four or more different elemental atoms 106a-106d, in a single particle having a maximum cross-sectional dimension, D, less than or equal to 1 μm, for example, in a range of 1-20 nm. The atoms in the nanoparticle can form a homogeneous mixture as a single-phase solid solution (e.g., having a face-centered cubic (FCC) phase). In some embodiments, the atoms 106a-106d are selected from transition metals, lanthanoids, actinoids, and post-transition metals.

In some embodiments, the HEA nanoparticle can be formed of platinum (Pt), palladium (Pd), rhodium (Rh), cobalt (Co), and a promoter (e.g., a rare-earth element, such as cerium). For example, an HEA nanoparticle for use as an ammonia oxidation catalyst can have a chemical composition of Pt₆₃Pd₁₅Rh₄Co₁₅Ce₃, which exhibit high selectivity, high conversion, and excellent stability. Alternatively, in some embodiments, an HEA nanoparticle formed of Pt, Pd, Rh, Co, and promoter can have the Pt content reduced (e.g., to within a range of 50-60 atom %) and the content of nonprecious metals (e.g., Co and/or the promoter) increased (e.g., ≥20 atom %).

Alternatively, in some embodiments, the HEA nanoparticle can be formed of cobalt (Co), molybdenum (Mo), and at least two elements from the group of transition metal elements (e.g., 3d transition metals, such as iron (Fe), nickel (Ni), copper (Cu), and manganese (Mn)). In some embodiments, the atomic elements 106a-106d can be selected to provide an atomic size difference, δ, and/or an enthalpy of mixing, ΔHₘᵢₓ, that forms, or is inclined to form, an HEA. For example, the atomic elements can be selected such that δ≤6.6% and/or −11.6<ΔHₘᵢₓ<3.2 KJ/mol. For example, an HEA nanoparticle for use as an ammonia decomposition catalyst can have a chemical composition of CoₓMo_{y}FeₐNi_{b}M′_{c}, where x+y=100−(a+b+c), 10≤a,b,c≤20, and M′ is Cu or Mn. In some embodiments, a, b, and c can be the same as each other (e.g., a=b=c=10) or different from each other.

In some embodiments, a plurality of HEA nanoparticles 102 are integrally formed on and supported by a substrate to form a catalytic structure. For example. FIG. 1B illustrates a catalytic structure 110 comprising a solid substrate 112 and a plurality of HEA nanoparticles 102. The solid substrate 112 can be composed of (e.g., consisting essentially of) a metal oxide, such as but not limited to aluminum oxide, titanium oxide, cerium oxide, silicon oxide, zeolite, spinel, and/or perovskite. The plurality of HEA nanoparticles 102 can be randomly arranged on and/or within the substrate 112, for example, with a minimum spacing, S, between adjacent nanoparticles 102 in a range of approximately 10-100 nm. In some embodiments, the substrate 112 can be porous (e.g., having a pore volume in a range of 0.6-0.8 mL/g, for example, as determined by a Brunauer-Emmett-Teller (BET) measurement), such that reactants 114 can flow through the catalytic structure 110, thereby generating a flow of products 126 (and/or carrier gas and/or potentially unreacted reactants) under the appropriate reaction conditions (e.g., reaction temperature).

In FIG. 1B, the substrate 112 is shown as a rectangular prism for convenient illustration. However, in practical implementations, the substrate can have a shape different than that illustrated in FIG. 1B. In some embodiments, the substrate can be an extruded metal oxide support having any shape, such as, but not limited to an irregular granule, sphere, hollow ring, cube, rectangular prism, cylinder, bilobed, trilobed, or quadrilobed. For example, in some embodiments, the substrate can be an aluminum-based extrudate pellet, such as that disclosed in European Patent No. 0 455 307 B1, issued Aug. 10, 1994 and entitled “Process for the preparation of alumina-based extrudates,” or U.S. Pat. No. 6,656,875 B1, issued Dec. 2, 2003 and entitled “Alumina extrudates, methods for preparing and use as catalysts supports,” both of which are incorporated herein by reference. For example, in some embodiments, the substrate can be a multi-lobe cylindrical pellet, such as that disclosed in U.S. Pat. No. 4,028,227 A, issued Jun. 7, 1977 and entitled “Hydrotreating of petroleum residuum using shaped catalyst particles of small diameter pores.” which is incorporated herein by reference. Alternatively or additionally, in some embodiments, the substrate with nanoparticles therein can be ground into a powder, for example, having a particle size less than or equal to 1 mm.

In some embodiments, the substrate 110 is an extruded metal oxide support, for example, as shown in FIGS. 1C-1D. The extruded metal oxide support can have a maximum cross-sectional dimension less than or equal to 20 mm, for example, a length in a range of 4-6.5 mm, inclusive, and a diameter in a range of 2.1-3.2 mm, inclusive. In some embodiments, the substrate 110 can be a porous structure exhibiting a surface area in a range of 175-225 m²/g, inclusive.

In the examples of FIGS. 1B-1D, the substrate 110 is formed entirely of metal oxide. Alternatively, in some embodiments, only part of the substrate may be formed of metal oxide, for example, an outermost layer upon which the HEA nanoparticles are formed. For example, FIG. 1E illustrates a catalytic structure 120 having a plurality of nanoparticles 102 formed on a composite substrate, in particular, having a base layer 124 and a metal-oxide coating 122. In some embodiments, the metal-oxide coating 122 can be formed of aluminum oxide, titanium oxide, cerium oxide, silicon oxide, zeolite, spinel, and/or perovskite, while the base layer 124 can be formed of a different material, such as a carbon-based material (e.g., carbon nanofibers). For example. FIG. 1F is an image of a fabricated catalytic structure having HEA nanoparticles formed on an alumina-coated carbon nanofiber. In some embodiments, the metal-oxide coating 122 can be formed over all internal and/or external surfaces of the base layer 124, for example, as a conformal coating (e.g., via atomic layer deposition). For example, the metal-oxide coating 122 can have a thickness less than or equal to approximately 100 nm.

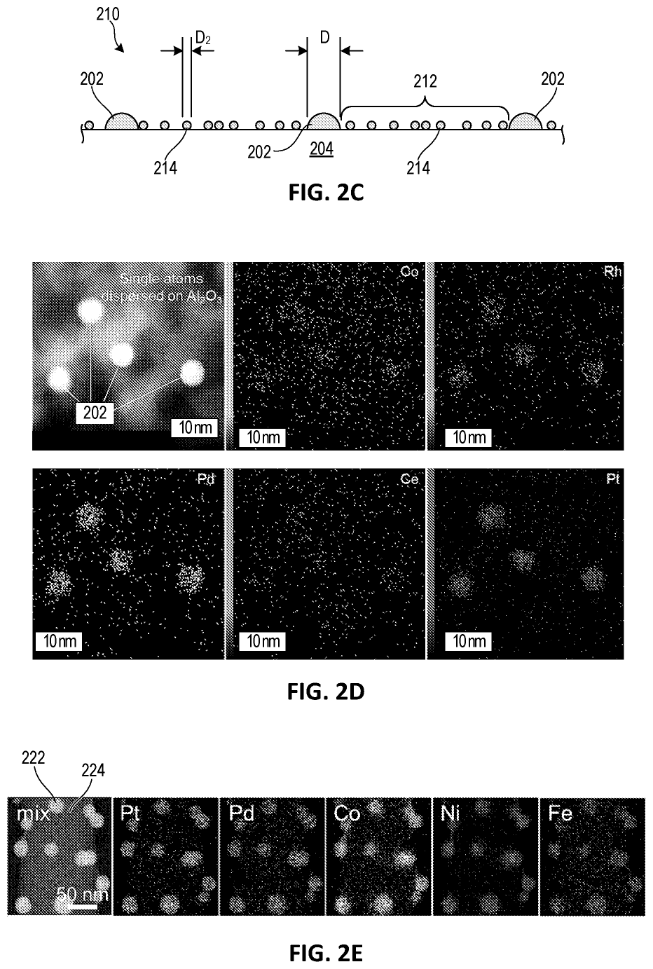

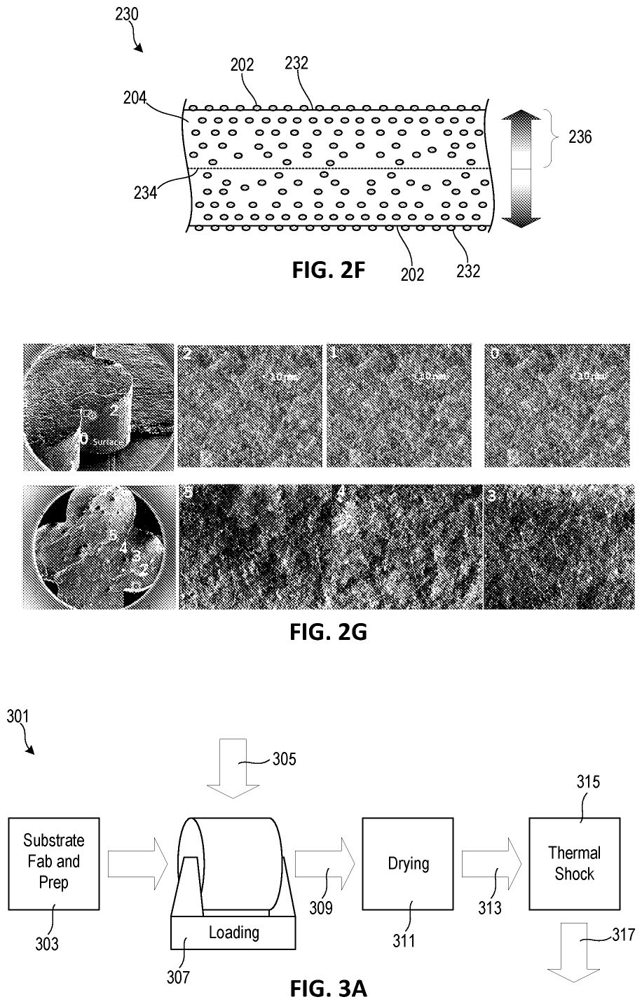

In the illustrated example of FIG. 1A, the HEA nanoparticle 102 is shown as substantially-spherical in shape. However, in some embodiments, the interaction between the elements of the HEA nanoparticle and the metal oxide of the substrate (e.g., between metals of the HEA nanoparticle and oxygen of the substrate) can cause the HEA nanoparticle to adopt a non-spherical shape. For example, FIG. 2A illustrates a catalytic structure 200 where HEA nanoparticles 202 formed on the metal-oxide substrate 204 of a substrate adopts a truncated spherical shape. FIG. 2B shows a fabricated example of an HEA nanoparticle having a truncated spherical shape, in particular, an HEA nanoparticle composed of Pt. Pd, Rh, Co, and Ce formed on an aluminum oxide substrate. In some embodiments, the non-spherical shape and/or interaction between the HEA nanoparticle and metal oxide can result in improved adhesion, reliability, and/or durability as compared to spherical shaped nanoparticles, for example, formed on carbon substrates.

In some embodiments, the use of metal oxide for the substrate surface may inhibit complete formation of HEA nanoparticles, such that at least some of the elements in the precursor starting materials form non-HEA particles on the substrate surface, for example, interposed between a plurality of formed HEA nanoparticles. For example, FIG. 2C illustrates a catalytic structure 210 where a plurality of non-HEA particles 214 have been formed on metal-oxide surface 204 in the interstitial region 212 between adjacent HEA nanoparticles 202. The non-HEA particles 214 can be formed at a same time and/or by the same process as the HEA nanoparticle 202, for example, due to interaction between the elements and the metal oxide of the substrate that inhibits mobility of the elements during the thermal shock process. In some embodiments, the number of the non-HEA particles formed on/within the substrate may be greater than the number of HEA nanoparticles formed on/within the substrate, and/or the size of the non-HEA particles (e.g., D₂ in FIG. 2C) may be less than that of the HEA nanoparticles. In some embodiments, some or all of the non-HEA particles may be single element particles (e.g., atoms). FIG. 2D shows a fabricated example of a catalytic structure with HEA nanoparticles composed of Pt. Pd, Rh, Co, and Ce and non-HEA particles (shown as dots) formed together on an aluminum oxide substrate. In contrast, FIG. 2E shows a fabricated example of a catalytic structure with HEA nanoparticles composed of Pt, Pd, Co, Ni, and Fe formed on a carbon-based substrate. Since the carbon-based substrate does not inhibit HEA nanoparticle formation, FIG. 2E does not show evidence of non-HEA particle formation (e.g., no dots outside the HEA nanoparticles).

In some embodiments, the plurality of HEA nanoparticles can be formed on and within the porous, solid substrate such that a distribution of nanoparticles varies through the cross-section of the substrate, for example, such that a particle density of the HEA nanoparticles is greater closer to external surfaces of the substrate and less at regions farther from the external surfaces of the substrate (e.g., closer to a center). For example, FIG. 2F illustrates a catalytic structure 230 with a plurality of HEA nanoparticles 202 formed on and within a metal-oxide substrate 204. The distribution of HEA nanoparticles 202 can follow a gradient 236, with the density and/or number of nanoparticles 202 being greater at external surfaces 232 as compared to a central region proximal to center 234. In some embodiments, gradient 236 can be substantially linear or non-linear. Alternatively or additionally, in some embodiments, a central interior region (e.g., proximal to center 234) can have a mass loading of HEA nanoparticles 202 that is 0-80% (e.g., ≤50%) of the mass loading of HEA nanoparticles 202 at the external surfaces 232 of the substrate 204. FIG. 2G shows a fabricated example of a catalytic structure where HEA nanoparticles are distributed in a gradient across the cross-section of an aluminum oxide substrate. In some embodiments, the non-uniform distribution of HEA nanoparticles can be beneficial for some reactions, for example, by providing a greater density of HEA nanoparticles closer to the substrate surface where reactants are more likely to interact with the nanoparticles.

In some embodiments, the HEA nanoparticle gradient may be a function of precursor loading on and into the porous solid substrate. For example, in some embodiments, the precursors can be loaded using a dry impregnation method, where the volume of precursor solution (e.g., metal salts in organic solvent or water) is less than or equal to the pore volume of the substrate. Capillary action can draw the precursor solution into the pores of the substrate until it was completed absorbed. The concentration profile for the precursor-loaded sample can depend on the mass transfer conditions within the pores during the impregnation, such that the precursors can be limited or confined to surface regions rather than the central interior region of the substrate. Exposure to thermal shock heating can convert the precursors into HEA nanoparticles, for example, primarily on the regions proximal to the surface with almost no HEA nanoparticles in the interior region. Alternatively, in some embodiments, the precursors can be loaded using a wet impregnation method, where the volume of precursor solution is greater than the pore volume of the substrate. For example, the metal oxide substrate can be immersed in the precursor solution (e.g., for hours, such as 24 hours) such that the precursors is absorbed into the substrate. The precursor loading may be substantially uniform. However, upon exposure to thermal shock heating, the HEA nanoparticles can be formed in a non-uniform distribution, for example, with the particle density gradually decreasing from the surface of the substrate toward the interior.

### Catalytic Structure Fabrication Systems

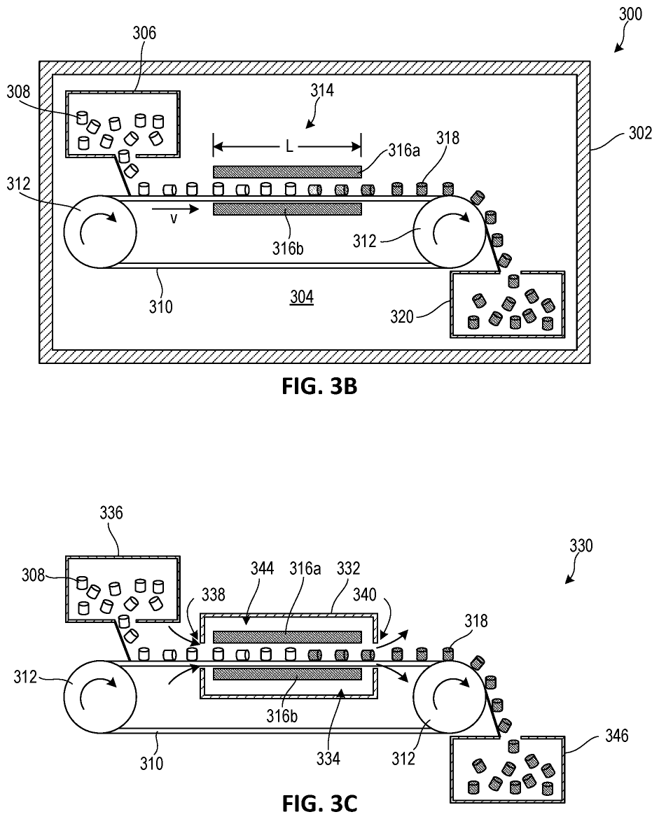

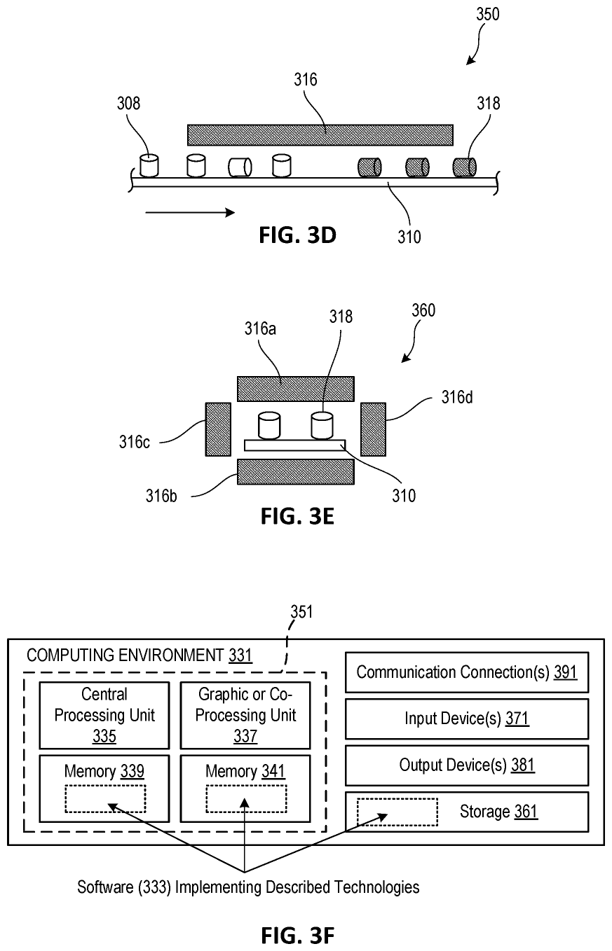

Referring to FIG. 3A, a generalized setup 301 for forming catalytic structures can involve a substrate fabrication and preparation stage 303, a precursor loading or impregnation stage 307, a drying stage 311, and a thermal shock heating stage 315. In the substrate fabrication and/or preparation stage 303, a substrate formed partially or entirely of a metal oxide can be provided. In some embodiments, stage 303 can involve fabrication of the substrate, for example, via extrusion and/or calcination of the metal oxide, formation of a carbon base layer, and/or coating with a metal oxide. Alternatively or additionally, in some embodiments, stage 303 can involve preparation of the substrate for subsequent precursor loading, for example, by removing moisture, altering crystallinity and/or porosity, and/or improving surface wettability.

The substrates can be provided to the precursor loading/impregnation stage 307, where they can be combined, coated, and/or mixed with solution 305 containing one or more precursors (e.g., a metal salt, such as chloride, nitrate, and/or alkoxide in an organic solvent or water). In some embodiments, the precursor loading/impregnation stage 307 can employ dry impregnation, wet impregnation, or both. In some embodiments, the mixing of the substrates and precursor solution can be performed using a rotary drum mixer. Other methods for combining, coating, and/or mixing are also possible according to one or more contemplated embodiments. In some embodiments, the precursor-loaded substrates 309 can be provided to the drying stage 311, for example, to remove the solvent (e.g., organic solvent or water) therefrom. In some embodiments, the drying stage 311 can employ freeze-drying or critical point drying, which may avoid or at least reduce loss of precursors and/or disruption of the distribution of precursors. For example, the freeze-drying or critical point drying can preserve a substantially uniform distribution of precursor salts in the solid state, which may in turn affect subsequent HEA particle size and/or distribution. Other methods for drying are also possible according to one or more contemplated embodiments.

The dried, precursor-loaded substrates 313 can be provided to the thermal shock heating stage 315, for example, to convert the precursors into HEA nanoparticles, thereby providing catalytic structures for subsequent use 317. In some embodiments, the thermal shock heating stage 315 subjects the precursor-loaded substrate to a short temporal pulse (e.g., less than 1 second) of high temperature (e.g., thermal shock temperature of at least 1200 K) such that the precursors self-assemble into a plurality of separated HEA nanoparticles on and within the substrate. In some embodiments, the short temporal pulse of high temperature can be achieved by moving the substrate through a spatially-restricted heating zone (e.g., where duration of the heating is determined by the size of the heating zone and speed of the substrate through the heating zone). Alternatively or additionally, in some embodiments, the short temporal pulse of high temperature can be achieved via pulsed operation of a heating element.

In some embodiments, the thermal shock heating stage can employ a Joule heating element, for example, similar to any of those disclosed in U.S. Publication No. 2018/0369771, entitled “Nanoparticles and systems and methods for synthesizing nanoparticles through thermal shock.” U.S. Publication No. 2019/0161840, entitled “Thermal shock synthesis of multielement nanoparticles,” International Publication No. WO 2020/236767, entitled “High temperature sintering systems and methods.” or International Publication No. WO 2020/252435, entitled “Systems and methods for high temperature synthesis of single atom dispersions and multi-atom dispersions,” which disclosed heating elements are incorporated herein by reference. Alternatively or additionally, in some embodiments, the thermal shock heating stage can employ microwave heating, laser heating, electron beam heating, spark discharge heating, or any other heating mechanism capable of providing a heating rate of at least 10³ K/s, a peak temperature of at least 1200 K, and/or a cooling rate of a least 10³ K/s.

In some embodiments, a system can be provided for forming a catalytic structure according to the setup 301 of FIG. 3A. In some embodiments, the system can include one or more process stations or systems corresponding to the different stages 303, 307, 311, and 315. For example, the system can include a substrate fabrication station to extrude metal-oxide substrates, an impregnation station to load the substrate with precursors, a drying station to remove solvent from the substrate, and a heating station for performing a thermal shock (e.g., furnace system 300 of FIG. 3B or furnace system 330 of FIG. 3C). In some embodiments, the system can include a controller or control module configured to control the various components of the system to perform the catalytic structure fabrication.

FIG. 3B illustrates a furnace 300 for thermal shock heating employing an enclosed or encapsulated setup. In the illustrated example, the various components of the furnace 300, including an input queue or hopper 306, a conveying assembly 310 with rollers 312 (e.g., drive rollers and/or passive support rollers), a pair of heating elements 316a, 316b, and an output collection bin 320, can be disposed within the internal volume 304 of a sealed (e.g., air-tight) enclosure 302. In some embodiments, the internal volume 304 of the enclosure 302 can be filled with a static or flowing inert gas (e.g., argon, nitrogen, or combinations thereof). The pair of heating elements 316a, 316b can be disposed on opposite sides of the conveying assembly 310 and can together define a heating zone 314 of length, L (e.g., 1-2 inches). In some embodiments, the conveying assembly 310 can be formed of a flexible material capable of being subjected to high temperatures (e.g., >1200 K) without substantial degradation, for example, a carbon cloth.

In operation, dried substrates 308 loaded with precursors are deposited from the input hopper 306 onto the conveying assembly 310, which transports the substrates 308 between the heating elements 316a, 316b and through the heating zone 314, thereby subjecting the substrates 308 to a thermal shock that converts the precursors into HEA nanoparticles. The resulting catalytic structures 318 (with HEA nanoparticles formed on metal oxide surface) are further transported from the heating zone 314 by conveying assembly 310 into output collection bin 320. In some embodiments, the operation of furnace 300 may be semi-continuous, for example, with the dispensing of substrates 308, transport by conveying assembly 310, heating by heating elements 316a, 316b, and collection of catalytic structures 318 continuing until the supply of substrates 308 in the input hopper 306 is exhausted. Alternatively, in some embodiments, the operation of furnace 300 may be continuous, for example, with the supply of substrates 308 being continuously or periodically replenished (e.g., by introduction of new substrates into the input hopper 306 via an air-lock or other mechanism).

In some embodiments, the duration of the thermal shock may be a product of the length, L, of the heating zone 314 and the velocity, v, of the conveying assembly 310 (e.g., t₁=L/v). The velocity (e.g., 60 inches/minute) of the conveying assembly 310 can be chosen to achieve a desired time duration of the thermal shock (e.g., ≤1 second, such as ≤500 milliseconds or even ≤100 milliseconds) and/or a desired heating ramp rate or cooling ramp rate (e.g., ≥10³ K/s). In such a configuration, the heating elements 316a, 316b may be continuously energized, for example, to provide a constant or substantially constant temperature (e.g., ≥1200 K) within the heating zone 314. Alternatively or additionally, in some embodiments, the heating elements 316a, 316b can be operated in a pulsed mode, for example, to provide a time-varying temperature profile in the heating zone 314.

In some embodiments, the heating elements 316a, 316b can be Joule heating elements, for example, formed of a carbon-based material (e.g., carbon felt). For example, the Joule heating element can be similar to any of the heating elements disclosed in U.S. Publication No. 2018/0369771, entitled “Nanoparticles and systems and methods for synthesizing nanoparticles through thermal shock,” U.S. Publication No. 2019/0161840, entitled “Thermal shock synthesis of multielement nanoparticles,” International Publication No. WO 2020/236767, entitled “High temperature sintering systems and methods.” and International Publication No. WO 2020/252435, entitled “Systems and methods for high temperature synthesis of single atom dispersions and multi-atom dispersions,” which disclosed heating elements are incorporated herein by reference. Instead of Joule heating, or in addition thereto, in some embodiments, the heating element can comprise any other heating source capable of producing a thermal shock profile, for example, a microwave heating source, a laser, an electron beam device, a spark discharge device, or any combination thereof.

In some embodiments, only part of the furnace may be enclosed in an inert environment, for example, to simplify material loading and/or unloading as well as to reduce system fabrication and/or operation costs. For example. FIG. 3C illustrates a furnace 330 for thermal shock heating employing an open setup. In the illustrated example, the heating elements 316a, 316b are disposed within an internal volume 334 of a protective enclosure 332, while the remaining components of the furnace 330, including input hopper 336, conveying assembly 310 with rollers 312, and output collection bin 346 are disposed outside of enclosure 332 (e.g., within an ambient environment, such as air). In the illustrated example, the protective enclosure 332 can be open to allow the conveying assembly 310 to pass therethrough. Alternatively or additionally, in some embodiments, a flow of shield gas (e.g., inert gas such as argon, nitrogen, or both) can be introduced to the protective enclosure 332, for example, via inlet stream 338 to protect the heating elements 316a, 316b. After passing through the heating zone, the shield gas can exit the protective enclosure 332, for example, as outlet stream 340.

In the illustrated examples of FIGS. 3B-3C, heating is provided by a pair of heating elements 316a, 316b on opposite sides (e.g., top and bottom) of the conveying assembly 310. However, in some embodiments, a different number of heating elements can be used. In some embodiments, a single heating element 316 can be disposed over the conveying assembly 310, for example, as shown in the setup 350 of FIG. 3D. Alternatively, in some embodiments, two pairs of heating elements can be disposed in an arrangement surrounding the conveying assembly 310, for example, with a first pair of heating elements 316a, 316b on a top and bottom of the conveying assembly 310 and a second pair of heating elements 316c, 316d on a left and right of the conveying assembly 310, as shown in FIG. 3E. In some embodiments, one, some, or all of the heating elements can be disposed in close proximity (e.g., ≤5 mm) to the substrates 308 and/or the conveying assembly 310, for example, to achieve a high and uniform temperature profile.

Although the illustrated examples show each heating element extending the length of the heating zone, embodiments of the disclosed subject matter are not limited thereto. Rather, multiple heating elements can be disposed along the length of the heating zone. Alternatively or additionally, in some embodiments, part of the conveying assembly 310 can be energized for serve as a bottom heating element, for example, by making electrical contact to part of the conveying assembly within the heating zone when the conveying assembly is formed of carbon. Other furnace setups and heating configurations are also possible according to one or more contemplated embodiments. For example, embodiments of the disclosed subject matter may employ any of the furnace setups or heating configurations disclosed in International Application No. PCT/US22/21915, filed Mar. 25, 2022 and entitled “High Temperature Sintering Furnace Systems and Methods,” which is incorporated herein by reference.

### Methods for Fabricating Catalytic Structures

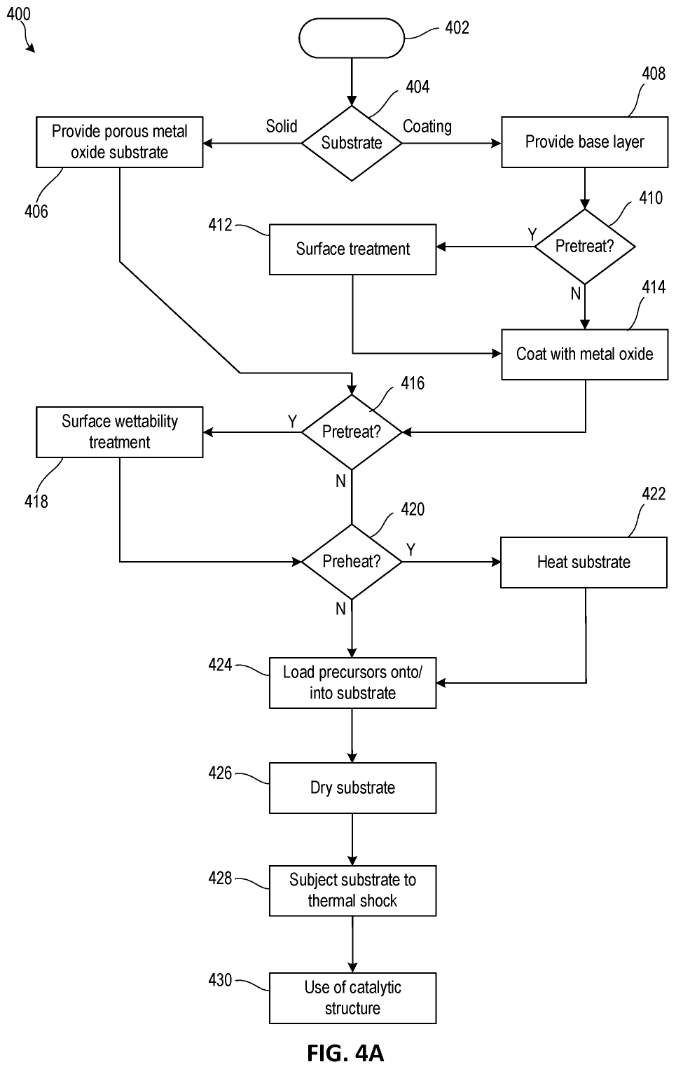

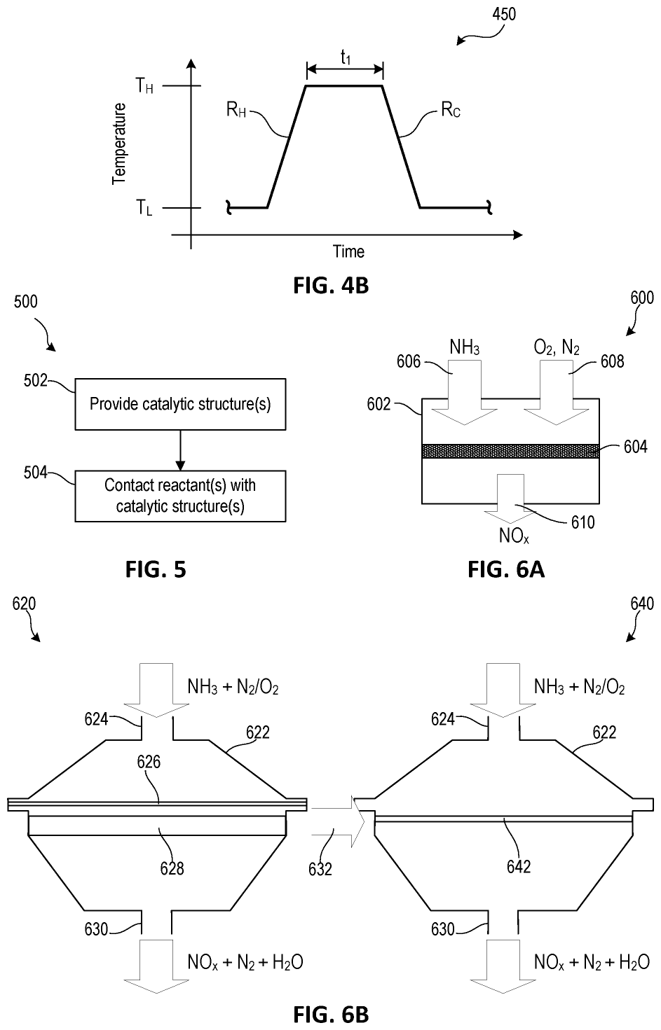

FIG. 4A illustrates a method 400 for fabricating catalytic structures. The method 400 can initiate at terminal block 402 and proceed to decision block 404, where a decision is made between a solid substrate or a coated substrate. If a solid substrate is desired, the method 400 can proceed to process block 406, where a porous, solid substrate formed of metal oxide (e.g., consisting essentially of one or more metal oxides) can be provided. In some embodiments, the solid substrate can be composed of aluminum oxide, titanium oxide, cerium oxide, silicon oxide, zeolite, spinel, and/or perovskite. For example, the solid substrate can be a metal-oxide extrudate pellet, such as a multi-lobe cylindrical pellet. In some embodiments, the provision of process block 406 can include fabricating the solid substrate, for example, by extruding and calcination.

Alternatively, if a coated substrate is instead desired, the method 400 can proceed to process block 408, where a base layer can be provided. In some embodiments, the base layer can be formed of a conductive material, such as conductive carbon (e.g., a network of carbon nanofibers (CNFs)). In some embodiments, the provision of process block 408 can include fabricating the base layer. For example, a polymer nanofiber network (e.g., polyacrylonitrile) can be formed by electrospinning and then carbonized (e.g., by heating at 900° C. for 2 hours) to yield the network of CNFs for subsequent use as the base layer. The method 400 can proceed from process block 408 to decision block 410, where it is determined if an optional pre-treatment is desired for the base layer. If pre-treatment is desired, the method 400 can proceed to process block 412, where a surface treatment (e.g., thermal activation to increase surface defect concentration) can be performed. In some embodiments, the surface treatment can be effective to create surface defects in a carbon base layer (e.g., for more effective nanoparticle dispersion). For example, when using CNF films as the base layer, the surface treatment can be at a temperature greater than or equal to 600° C. (e.g., 600-1000° C., such as 750° C.) for at least 1 hour (e.g., ˜2 hours) in a carbon dioxide atmosphere.

If pretreatment was not desired at decision block 410, or after completion of the surface treatment of process block 412, the method 400 can proceed to process block 414, where the base layer can be coated with one or more metal oxide layers. For example, the coating can be composed of aluminum oxide, titanium oxide, cerium oxide, silicon oxide, zeolite, spinel, and/or perovskite. In some embodiments, the metal oxide coating on the base layer can have a thickness less than or equal to 100 nm, for example, ˜20 nm. In some embodiments, the metal oxide coating can be a conformal coating over all internal (within pores) and external surfaces of the base layer, for example, via atomic-layer deposition (ALD).

The method 400 can proceed from process block 414 or process block 406 to decision block 416, where it is determined if another optional pre-treatment is desired. If pre-treatment is desired, the method 400 can proceed to process block 418, where a treatment is performed to enhance wettability of exposed surfaces of the metal oxide. In some embodiments, the treatment to enhance wettability can include a plasma treatment and/or an acid treatment, for example, as disclosed in Achour et al., “Influence of plasma functionalization treatment and gold nanoparticles on surface chemistry and wettability of reactive-sputtered TiO₂ thin films,” Applied Surface Science, July 2018, Issue 458, pp. 678-85, which is incorporated herein by reference. Other metal-oxide surface treatments are also possible according to one or more contemplated embodiments.

If pretreatment was not desired at decision block 416, or after completion of the treatment of process block 418, the method 400 can proceed to decision block 420, where it is determined if preheating of the substrate is desired. If preheating is desired, the method 400 can proceed to process block 422, where the substrate can be heated. For example, in some embodiments, the substrate can be heated at a temperature in a range of 100-200° C. (e.g., 105° C. for 4 hours) to remove moisture therefrom. Alternatively or additionally, in some embodiments, the substrate can be heated at a temperature in a range of 800-1500° C. in an inert gas atmosphere (e.g., argon, nitrogen, or both) to increase crystallinity. For example, the increased crystallinity may decrease the surface area of the substrate, which may in turn alter (e.g., reduce) precursor loading capacity and/or alter (e.g., enhance) the catalytic effect of the final structure. Other preheating regimens and effects are also possible according to one or more contemplated embodiments.

If preheating was not desired at decision block 420, or after completion of the preheating of process block 422, the method 400 can proceed to process block 424, where HEA particle precursors can be loaded onto the substrate, for example, onto the internal or external metal oxide surfaces. The loading of precursors can mirror the desired composition for the mixture of the resulting of the HEA nanoparticles, for example, such that a desired atomic ratio of elements is attained. However, evaporation of elements can occur during the thermal shock heating phase. Accordingly, in some embodiments, the content of loaded precursors can be adjusted (e.g., increased) to compensate for any elemental loss and to achieve a targeted HEA nanoparticle composition.

In some embodiments, the loading can comprise coating, impregnating, and/or infiltrating the precursors onto and/or into the substrate, for example, via a wet impregnation technique (e.g., where the precursor solution volume is greater than the pore volume of the substrate) or a drying impregnation technique (e.g., where the precursor solution volume is less than or equal to the pore volume of the substrate). In some embodiments, the loading can be performed by mixing precursors (e.g., metal salts, such as chloride, nitrate, or alkolide) in solution (e.g., organic solvent or water) with the substrates, for example, using a rotary drum mixer. For example, the precursor can have a chemical formula of MClₓH_{y}, where M is a metal (e.g., Pt, Pd, Ni, Fe, Co, Au. Cu. Sn, etc.), x is equal to or greater than 1, and y is equal to or greater than 0. Other loading methods are also possible according to one or more contemplated embodiments. For example, the precursor loading can include dip coating, brushing, spraying, printing, rolling, incipient wetness spray impregnation, agitated drying, or any combination of the foregoing.

The method 400 can proceed to process block 426, where the precursor-loaded substrate can be dried, for example, to remove solvent therefrom. In some embodiments, the drying can be controlled to avoid agglomeration, detachment, and/or precipitation of the precursors, for example, to enhance or ensure a uniform precursor distribution. In some embodiments, the substrate can be dried via freeze-drying or critical point drying. Alternatively, in some embodiments, the substrate can be subject to oven drying, for example, at a temperature in a range of 20-120° C.

The method 400 can proceed to process block 428, wherein the dried substrate with loaded precursors can be subject to thermal shock heating. The thermal shock heating can be achieved by a pulsed heating profile 450, with (i) a rapid heating ramp, RH (e.g., ≥10³ K/s, such as 10⁴-10⁵ K/s, inclusive), (ii) a short dwell period, t₁ (e.g., 1 μs to 10 s, such as ≤500 ms), at or about peak temperature, T_{H} (e.g., 1200-3000 K, such as 1500-2300 K), and (iii) a rapid cooling ramp, R_{C} (e.g., ≥10³ K/s, such as 10⁴-10⁶ K/s, inclusive), for example, as shown in FIG. 4B. Alternatively, in some embodiments, the thermal shock process 428 may be performed more than once (e.g., by subjected to multiple pulsed temperature profiles). In some embodiments, the peak temperature can be sufficient to melt all of the constituent elements and/or induce high temperature uniform mixing, while the rapid cooling can enable crystallization of liquid elements into substantially uniform and homogeneous alloy nanoparticles without being subjected to aggregation, agglomeration, element segregation, or phase separation. Thus, a catalytic structure, which comprises the substrate and HEA nanoparticles thereon, can be produced by the thermal shock process.

In some embodiments, the temperature profile 450 can provide a rapid transition to and/or from the peak temperature T_{H}, for example, from/to a low temperature TL, such as room temperature (e.g. 20-25° C.) or an elevated ambient temperature (e.g., 100-200° C.)). In some embodiment, the heating of the thermal shock process can be provided by Joule heating, microwave heating, laser heating, electron beam heating, spark discharge heating, or any other heating mechanism capable of providing the desired heating rate and temperatures. In some embodiments, the thermal shock process can be terminated by conveying the substrates out of a heating zone and/or by de-activating, de-energizing, or otherwise terminating operation of the heating elements. Alternatively or additionally, in some embodiments, the cooling can be achieved using one or more passive cooling features (e.g., heat sinks thermally coupled to the heating element and/or substrate, etc.), one or more active cooling features (e.g., fluid flow directed at the substrate and/or the heater, fluid flow through the substrate or a heat sink thermally coupled thereto, etc.), or any combination thereof.

After the thermal shock of process block 428, the method 400 can proceed to process block 430, where the catalytic structure can be used (e.g., as described below with respect to FIG. 5) or otherwise adapted for subsequent use. In some embodiments, the catalytic structure can be subjected to crushing and/or grinding, for example, to transform the catalytic structure from a bulk material into a powder (e.g., having a particle size ≤1 mm). Alternatively or additionally, the catalytic structure, or multiple catalytic structures, can be assembled together in an appropriate holding structure (e.g., an array of Raschig ring) for installation in a reactor. In some embodiments, the catalytic structure can be used in a thermochemical or thermocatalytic reaction, such as but not limited to ammonia (NH₃) synthesis, ammonia oxidation, ammonia decomposition, and/or NOₓ reduction (e.g., de-NOₓ).

Although illustrated separately, it is contemplated that various process blocks may occur simultaneously or iteratively. Furthermore, certain process blocks illustrated as occurring after others may indeed occur before. Although some of blocks 402-430 of method 400 have been described as being performed once, in some embodiments, multiple repetitions of a particular process block may be employed before proceeding to the next decision block or process block. In addition, although blocks 402-430 of method 400 have been separately illustrated and described, in some embodiments, process blocks may be combined and performed together (simultaneously or sequentially). Moreover, although FIG. 4A illustrates a particular order for blocks 402-430, embodiments of the disclosed subject matter are not limited thereto. Indeed, in certain embodiments, the blocks may occur in a different order than illustrated or simultaneously with other blocks.

### Computer Implementation

FIG. 3F depicts a generalized example of a suitable computing environment 331 in which the described innovations may be implemented, such as but not limited to aspects of method 400, method 500, method 650, a controller of furnace system 300, a controller of furnace system 330, and/or a controller of a chemical reaction system. The computing environment 331 is not intended to suggest any limitation as to scope of use or functionality, as the innovations may be implemented in diverse general-purpose or special-purpose computing systems. For example, the computing environment 331 can be any of a variety of computing devices (e.g., desktop computer, laptop computer, server computer, tablet computer, etc.).

With reference to FIG. 3F, the computing environment 331 includes one or more processing units 335, 337 and memory 339, 341. In FIG. 3F, this basic configuration 351 is included within a dashed line. The processing units 335, 337 execute computer-executable instructions. A processing unit can be a central processing unit (CPU), processor in an application-specific integrated circuit (ASIC), or any other type of processor (e.g., hardware processors, graphics processing units (GPUs), virtual processors, etc.). In a multi-processing system, multiple processing units execute computer-executable instructions to increase processing power. For example, FIG. 3F shows a central processing unit 335 as well as a graphics processing unit or co-processing unit 337. The tangible memory 339, 341 may be volatile memory (e.g., registers, cache, RAM), non-volatile memory (e.g., ROM, EEPROM, flash memory, etc.), or some combination of the two, accessible by the processing unit(s). The memory 339, 341 stores software 333 implementing one or more innovations described herein, in the form of computer-executable instructions suitable for execution by the processing unit(s).

A computing system may have additional features. For example, the computing environment 331 includes storage 361, one or more input devices 371, one or more output devices 381, and one or more communication connections 391. An interconnection mechanism (not shown) such as a bus, controller, or network interconnects the components of the computing environment 331. Typically, operating system software (not shown) provides an operating environment for other software executing in the computing environment 331, and coordinates activities of the components of the computing environment 331.

The tangible storage 361 may be removable or non-removable, and includes magnetic disks, magnetic tapes or cassettes, CD-ROMs. DVDs, or any other medium which can be used to store information in a non-transitory way, and which can be accessed within the computing environment 331. The storage 361 can store instructions for the software 333 implementing one or more innovations described herein.

The input device(s) 371 may be a touch input device such as a keyboard, mouse, pen, or trackball, a voice input device, a scanning device, or another device that provides input to the computing environment 331. The output device(s) 371 may be a display, printer, speaker, CD-writer, or another device that provides output from computing environment 331.

The communication connection(s) 391 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or any other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java™, Python®, and/or any other suitable computer language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### Reactions Utilizing Catalytic Structures

FIG. 5 illustrates a generalized method 500 for use of catalytic structures. The method 500 can initiate a process block 502, where a catalytic structure is provided. The catalytic structure can comprise a substrate having a plurality of HEA nanoparticles. In some embodiments, the substrate can be formed entirely of metal oxide or can have at least an outermost layer formed of metal oxide and upon which the HEA nanoparticles are formed. In some embodiments, the composition of HEA nanoparticles can be selected for use in a particular chemical reaction. In some embodiments, the provision of process block 502 can include fabricating the catalytic structure, for example, according to method 400 of FIG. 4A. Alternatively or additionally, the provision of process block 502 can include installing the catalytic structure in an appropriate reactor for performing a chemical reaction.

The method 500 can proceed to process block 504, where the catalytic structure can be employed in the chemical reaction, for example, by contacting reactants (e.g., gases) with the HEA nanoparticles of the catalytic structure. In some embodiments, the chemical reaction can be ammonia synthesis, ammonia oxidation, ammonia decomposition, or NOₓ reduction (e.g., de-NOₓ). In some embodiments, the substrate of the catalytic structure is porous, and the contacting can comprise flowing reactants through the porous substrate. Alternatively or additionally, in some embodiments, the contacting can comprise flowing reactants parallel to a surface of the substrate upon which the HEA nanoparticles are formed. In some embodiments, the catalytic structure, the reactants, and/or an environment containing the catalytic structure and the reactants can be subject to heating, for example, to provide energy to initiate and/or drive the chemical reaction. For example, the heating may be such that the reactants and/or HEA nanoparticles are subjected to (or maintained at) a peak temperature of 300-600° C., such as ˜500° C. For example, the reactants can be ammonia and the products can be hydrogen and nitrogen for a thermochemical reaction involving ammonia decomposition, or vice versa for a thermochemical reaction involving ammonia synthesis.

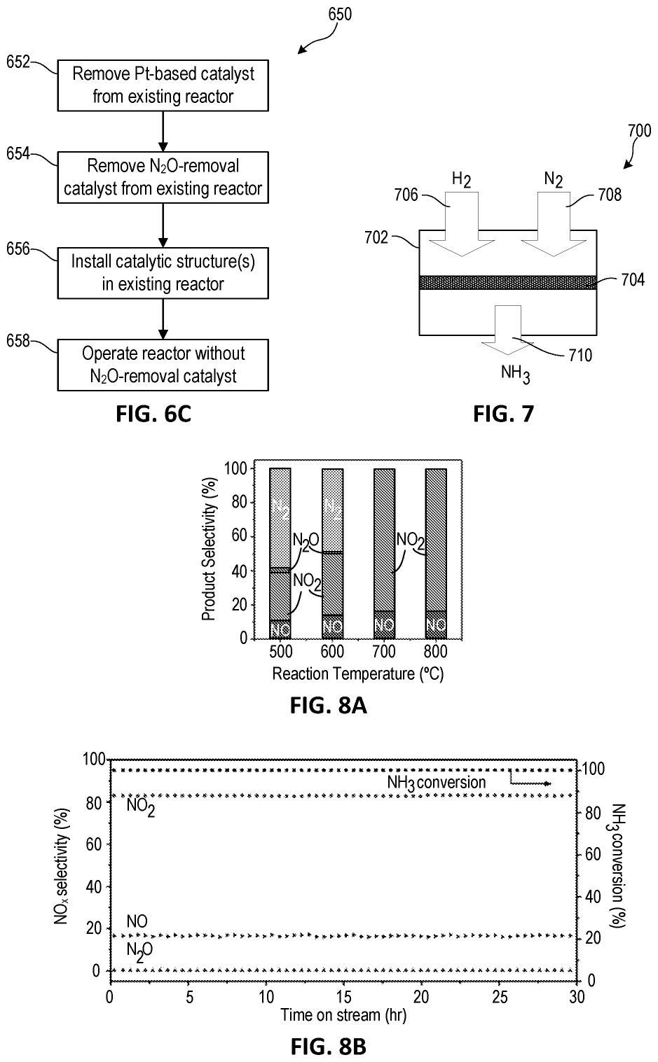

For example, FIG. 6A illustrates a setup 600 for an ammonia oxidation reaction, where a reactor 602 employs a catalytic structure 604 having HEA nanoparticles formed on a metal-oxide substrate. In some embodiments, the HEA nanoparticles of the catalytic structure 604 have at least Pt, Pd, and Rh, for example, a combination of Pt, Pd, Rh, Co, and a promoter (e.g., a rare-earth element). Ammonia 606 and oxygen and/or nitrogen 608 (e.g., air) can be provided as reactants in the reactor 602, which, when contacted with the catalytic structure 604 at temperature (e.g., ≤800° C.) can react to form a product stream at outlet 610. In some embodiments, the product outlet can include NOₓ products, where x=1 or 2. For example, the catalyzed reaction may be such that at least 90% of the products at the outlet 610 are NOₓ products, and/or less than or equal to 1% of the products at the outlet 610 are N₂O. Alternatively or additionally, the catalyzed reaction can be such that at least 95% of the ammonia 606 can be converted to products. In some embodiments, the catalyzed reaction can be such that reactor 602 can operate without a de-N₂O catalyst.

In some embodiments, reactor 602 can be constructed as a slip-stream unit, for example, for operational testing within the configuration of an existing nitric acid plant. In some embodiments, the slip-stream unit can be skid-mounted, for example, to allow the reactor to be built away from and transported to/from the existing plant. In some embodiments, the slip-stream unit can take advantage of available plant ammonia and air supplies, and the exhaust NOₓ stream from the slip-stream unit can be sent back to the plant for conversion into nitric acid. For example, the slip-stream unit can operate at a pressure equal to or less than that of the ammonia vaporizer pressure of the existing plant. Alternatively or additionally, the slip-stream unit can operate at a pressure greater than or equal to the plant pressure downstream of the ammonia oxidation reactor. In some embodiments, the slip-stream unit can have an ammonia inlet nozzle, an air inlet nozzle, and a NOₓ gas exit nozzle, all of which can be connected via piping at the plant site.

In existing nitric acid plants, ammonia is vaporized and superheated to assure all ammonia is in a vapor state for accurate monitoring (e.g., via a flow meter). Down-stream of the superheater is a flow control valve followed by the ammonia flow meter. In some embodiments, the ammonia source for the slip-stream unit can be provided downstream of the ammonia superheater, but upstream of the ammonia control valve. This input stream can flow to the slip-stream unit in a well-insulated electric- or steam-traced piping, such that the inlet ammonia temperature can remain in a vapor state for the slip-stream unit instrumentation. In some embodiments, air inlet supply can be taken from the plant air compressor or supplied by a separate compressor dedicated to the slip-stream unit. In some embodiments, the slip-stream unit can have an analyzer to measure reacted gas composition. The reacted gas can be fed from the slip-stream unit back into the plant at any location between the ammonia oxidation reactor and the absorption tower.

Alternatively, in some embodiments, reactor 604 can be achieved by retrofitting an ammonia oxidation reactor in an existing nitric acid plant. Commercial nitric acid plants rely on Pt—Rh gauze catalysts for ammonia oxidation. In addition, a de-N₂O catalyst is typically employed to remove the undesired side product, N₂O, for example, to mitigate polluting emissions. For example, an ammonia oxidation reactor 622 (e.g. pancake reactor) in a conventional nitric acid plant setup 620 is shown in FIG. 6B. The ammonia oxidation reactor 622 has at least one inlet 624 for reactants (e.g., ammonia, nitrogen, and oxygen), at least one outlet 630 for products (e.g., NOₓ, nitrogen, and water), an upstream catalyst 626 (e.g., a Pt—Rh gauze), and a downstream catalyst 628 for N₂O removal. The N₂O-removal catalyst 628 is typically in the form of cylindrical extrudates supported by an array of Raschig rings. In some embodiments, the ammonia oxidation reactor 622 can be subject to retrofitting 632, for example, by removing the existing catalysts 626, 628 and replacing with catalytic structures 642 employing HEA nanoparticles on a metal oxide substrates. Because the high activity and selectivity of the HEA catalysts toward NO and NO₂ minimizes the production of N₂O, the retrofit production setup 640 can operate without requiring additional de-N₂O catalysts.

Referring to FIG. 6C, a method 650 for retrofit operation of an ammonia oxidation reactor is shown. The method 650 can initiate a process block 652, where the existing Pt-based catalyst (e.g., Pt—Rh gauze) is removed from the ammonia oxidation reactor. At process block 654, the existing N₂O-removal catalyst can also be removed from the ammonia oxidation reactor. At process block 656, one or more catalytic structures, each of which includes HEA nanoparticles formed on metal oxide substrates, can be installed in the ammonia oxidation reactor. At process block 65, the ammonia oxidation reactor can subsequently operate without requiring a separate N₂O-removal catalyst.

Although illustrated separately, it is contemplated that various process blocks may occur simultaneously or iteratively. For example, existing catalyst removal of process blocks 652 and 654 can occur simultaneously despite being illustrated as sequential process blocks. Furthermore, certain process blocks illustrated as occurring after others may indeed occur before. Although some of blocks 652-658 of method 650 have been described as being performed once, in some embodiments, multiple repetitions of a particular process block may be employed before proceeding to the next decision block or process block. In addition, although blocks 652-658 of method 650 have been separately illustrated and described, in some embodiments, process blocks may be combined and performed together (simultaneously or sequentially). Moreover, although FIG. 6C illustrates a particular order for blocks 652-658, embodiments of the disclosed subject matter are not limited thereto. Indeed, in certain embodiments, the blocks may occur in a different order than illustrated or simultaneously with other blocks.

FIG. 7 illustrates a setup 700 for an ammonia synthesis reaction, where a reactor 702 employs a catalytic structure 704 having HEA nanoparticles formed on a metal-oxide substrate. In some embodiment, the HEA nanoparticles of the catalytic structure 704 have at least Co and Mo, for example, a combination of Co, Mo, and at least two transition metals. For example, the homogeneous mixture in each HEA nanoparticle can satisfy the formula CoₓMo_{y}FeₐNi_{b}M′_{c}, where x+y=100−(a+b+c). 10≤a≤20, 10≤b≤20, 10≤c≤20, and M′ is Cu or Mn. Hydrogen 706 and nitrogen 708 can be provided as reactants in the reactor 702, which, when contacted with the catalytic structure 704 at temperature (e.g., 300-600° C., e.g., ˜ 450° C.) can react to form a product stream at outlet 710. In some embodiments, the product outlet can include ammonia. For example, the catalyzed reaction may be such that a mass-specific reaction rate of the chemical reaction is at least 0.7 gₐₘₘₒₙᵢₐ gₘₑₜₐₗₛ⁻¹ h⁻¹, for example, ˜1.52 gₐₘₘₒₙᵢₐ gₘₑₜₐₗₛ⁻¹ h⁻¹.

### Fabricated Examples and Experimental Results

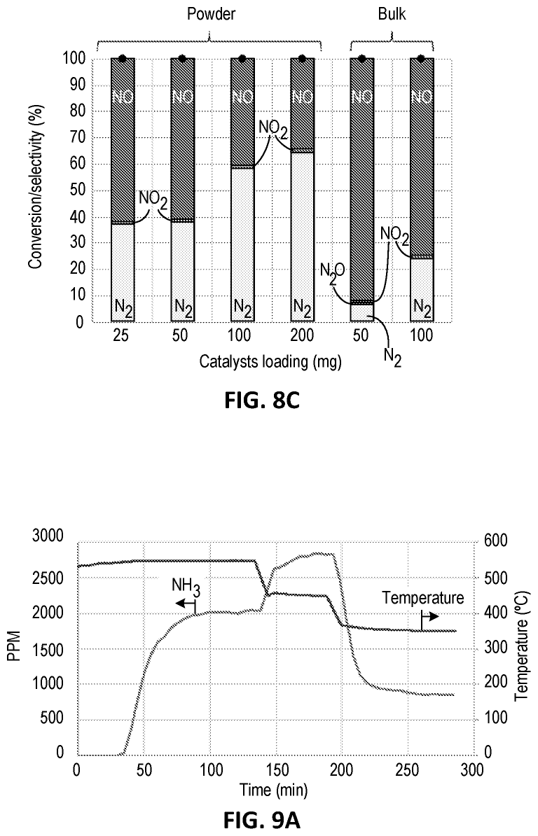

Alumina (Al₂O₃) extrudates were impregnated with metal salt solutions of designed concentrations. After drying, the precursor-loaded alumina substrates were loaded on a carbon belt, which carried the materials manually through a HTS zone created by a Joule heater. The metal salts were directly converted into HEA nanoparticles in less than 1 second by the radiative thermal shock. Color of the extrudates changed from yellowish brown (originating from the metal salt precursors) to black after the HTS treatment. Elemental mapping analysis showed uniform distribution of the HEA elements across the alumina substrate, indicating the formation of homogeneous alloy catalysts. The HEA nanoparticles were formed as quinary nanoparticles having a chemical composition of Pt₆₃Pd₁₅Rh₄Co₁₅Ce₃ and used as ammonia oxidation catalysts. As shown in FIG. 8A, the catalytic structure can achieve approximately 100% conversion of ammonia and >99% NOₓ selectivity at 700° C. whereas commercial Pt—Rh gauze catalysts require >900° C. to achieve similar performance. As shown in FIG. 8B, the catalytic structures comprising HEA nanoparticles show stable performance for extended operations.

The performance of the Pt₆₃Pd₁₅Rh₄Co₁₅Ce₃ nanoparticles on the alumina substrate for ammonia oxidation reactions was optimized based on a 1000 ppm ammonia feed concentration, in particular, by varying the temperature, flow rate. O₂ feed concentration (6000 ppm), substrate morphology (bulk extruded alumina versus powderized extruded alumina) and catalyst loading. In the ammonia oxidation reaction, excess catalyst can lead to secondary transformations of NOₓ products, namely the reduction of NOₓ to N₂ by reacting with NH₃, and NOₓ decomposition to N₂ and O₂, thereby lowering the efficiency. The powder form of the HEA catalyst was used to study the catalyst loading optimization. As shown in FIG. 8C, the catalyst loading was determined as approximately 50 mg. In order to compare the effect of substrate morphology, 100 mg bulk form HEA catalyst was used in order to keep the metal loading constant. The bulk form of the HEA catalyst demonstrated improved NOₓ selectivity. Decreasing the amount of bulk form to 50 mg catalyst used further improved the NOₓ selectivity. At 750° C., the Pt₆₃Pd₁₅Rh₄Co₁₅Ce₃@Al₂O₃ catalyst achieved approximately 100% conversion of NH₃ and greater than approximately 93% yield of NOₓ (NO+NO₂), while the N₂O selectivity (undesired) is less than approximately 0.1%. This catalyst enabled a reduction of reaction temperature by approximately 200° C. compared to the commercial Pt—Rh gauze catalysts, yet with improved selectivity.

Catalytic studies were performed using a tubular reactor with quinary Pt₆₃Pd₁₅Rh₄Co₁₅Ce₃ nanoparticles on alumina substrate (with a metal content of 5-10 wt %) as ammonia oxidation catalyst. Elemental mapping analysis showed that the HEA remains homogeneous after the reaction, demonstrating great stability under the harsh reaction conditions. In comparison, commercial Pt₉₅Rh₅ gauzes delivered approximately 95% yield of NOₓ at 850° C. with similar catalyst loadings (with 100 wt % precious metal content), yet with discernible degradation in reactivity. These results indicate that the HEA catalysts possess enhanced activity, selectivity and durability as compared to the state-of-the-art Pt—Rh gauzes for NH₃ oxidation. The lowering of reaction temperature needed for efficient conversion of NH₃ into NOₓ by 100-200° C., together with the demonstrated durability enhancement and high catalyst stability, is expected to greatly benefit the industrial operations by improving the catalyst lifetime, mitigating precious metal loss, and reducing down time for catalyst replacements. These benefits, as well as the straight cost reduction originating from the reduced usage of precious metals (by >80%), can improve the energy efficiency and economics of nitric acid plants.

CoMo-HEA nanoparticles dispersed on Al₂O₃-coated carbon paper were fabricated and employed for ammonia synthesis, exhibiting a catalytic activity of 0.40 g_{NH3} gₘₑₜₐₗ⁻¹ h⁻¹ at 500° C. and 10 bar. Substrate with a large specific surface area can improve the nanoparticle loading. IN some embodiments, CO₂ activation can be used to increase the specific surface area of the carbon paper substrate so that the loading of HEA dispersed on Al₂O₃-coated carbon paper can be enhanced. With increases in the activated temperature, the fiber diameter of the carbon paper can decrease, e.g., down to 2 μm for carbon paper activated at 1000° C. for 3 hours, thereby significantly enhancing the surface area. The carbon paper without/with CO₂ activation was coated with an oxide layer (˜20 nm) by using the atomic layer deposition (ALD). As a result, a uniform Al₂O₃ layer was obtained onto the surface of the carbon paper substrates.

Metal precursor salts (CON₂O₆·6H₂O, MoCl₃, FEN₃O₉.9H₂O, NiN₂O₆·6H₂O, and CuN₂O₆·6H₂O) were dissolved in ethanol to form a solution of 0.05 mol L⁻¹. The composition was set as Co₂₅Mo₄₅Fe₁₀Ni₁₀Cu₁₀. The solution was loaded onto Al₂O₃-coated carbon paper with the designed loadings, and then dried at room temperature prior to high-temperature heating. High-temperature thermal shock synthesis (˜1700 K, ˜55 ms) was conducted to in situ heat the films in an argon atmosphere, leading to the formation of ultrafine HEA nanoparticles dispersed on the carbon paper substrate. Uniform and high-density dispersion of CoMo-HEA nanoparticles on Al₂O₃-coated carbon paper with CO₂ activation was achieved, with nanoparticle size decreasing when using the carbon paper substrate activated at 1000° C. due to its high specific surface area. In addition, CoMo-HEA precursors were uniformly dispersed on extruded alumina (Al₂O₃) substrates. After high-temperature shock treatment, CoMo-HEA nanoparticles were formed on the alumina substrates. High-resolution EDX mapping confirmed the presence of all five elements (Co, Mo, Fe, Ni, and Cu) in the HEA nanoparticles on an Al substrate.

Depositing precursors and/or forming nanoparticles on the extruded alumina substrate can be different from that on other substrates like Al₂O₃-coated carbon paper. In particular, metal elements can be more prone to dissolution into the extruded alumina substrate, which can impede subsequent formation of nanoparticles by thermal shock heating. To address this, the precursor loading can be varied (e.g., in a range of 2.5-10 wt %) and/or by introducing a substrate treatment (e.g., annealing at high temperature and/or functionalizing the substrate) to promote HEA nanoparticle formation.

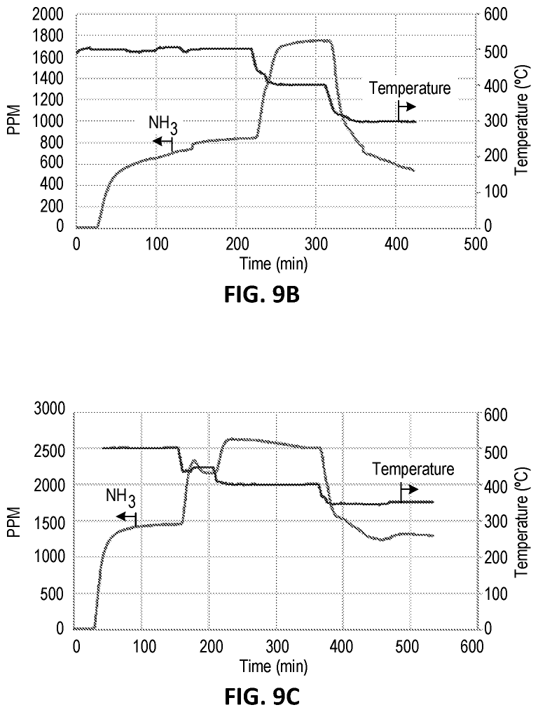

The catalyst was initially activated in situ under standard reaction conditions at 500° C. where activity initializes after ˜1 hours under these conditions. As shown in FIG. 9A, optimal temperature for this catalyst was observed around 450° C. at 10 bar and 50 sccm reactant gas flow, at which the catalytic ammonia synthesis rate was 1.52 g_{NH3} gₘₑₜₐₗ⁻¹ hr⁻¹. Higher flow rates and pressures may further improve the catalytic activity. Compared with the substrate of Al₂O₃-coated carbon paper without/with CO₂ activation, extruded Al₂O₃ substrates exhibited much better thermal stability, relatively high surface area, and easier large-scale synthesis.

For the extruded Al₂O₃ substrate, two morphologies were evaluated for catalytic activity: bulk form and powder form (made by crushing the bulk form prior to impregnation.) Both morphologies proved to be active for ammonia synthesis. The bulk form achieved 0.99 g_{NH3} gₘₑₜₐₗ⁻¹ hr⁻¹ at 400° C., 10 bar, and 50 sccm (as shown in FIG. 9B), while the powder form was slightly less active, achieving 0.71 g_{NH3} gₘₑₜₐₗ⁻¹ hr⁻¹ under the same reaction conditions (as shown in FIG. 9C). These catalysts also did not require any pretreatment prior to catalytic activity tests. They were activated in the same way as the HEA on Al₂O₃-coated carbon paper, i.e., at 500° C. and 10 bar.

### Additional Examples of the Disclosed Technology

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.
Clause 1. A catalytic structure comprising:
   a substrate, at least a surface layer of the substrate being formed of a metal oxide; and
   a plurality of high-entropy alloy (HEA) nanoparticles formed on the surface layer of the substrate, each HEA nanoparticle having a maximum cross-sectional dimension less than or equal to 1 μm, each HEA nanoparticle comprising a homogeneous mixture of at least four different elements forming a single-phase solid-solution alloy.
Clause 2. The catalytic structure of any clause or example herein, in particular, Clause 1, wherein an entirety of the substrate is formed of the metal oxide.
Clause 3. The catalytic structure of any clause or example herein, in particular, any one of Clauses 1-2, wherein the substrate comprises a base layer formed of a material different than the metal oxide.
Clause 4. The catalytic structure of any clause or example herein, in particular, Clause 3, wherein the base layer is formed of carbon.
Clause 5. The catalytic structure of any clause or example herein, in particular, any one of Clauses 1-4, wherein the maximum cross-sectional dimension of each HEA nanoparticle is less than or equal to 25 nm.
Clause 6. The catalytic structure of any clause or example herein, in particular, any one of Clauses 1-5, wherein the maximum cross-sectional dimension of each HEA nanoparticle is in a range of 1-20 nm, inclusive.
Clause 7. The catalytic structure of any clause or example herein, in particular, any one of Clauses 1-6, wherein the metal oxide comprises aluminum oxide, titanium oxide, cerium oxide, silicon oxide, zeolite, spinel, perovskite, or any combination of the foregoing.
Clause 8. The catalytic structure of any clause or example herein, in particular, any one of Clauses 1-7, wherein a noble metal content of the catalytic structure is less than or equal to 30 wt %.
Clause 9. The catalytic structure of any clause or example herein, in particular, any one of Clauses 1-8, wherein a noble metal content of the catalytic structure is in a range of 2-10 wt %, inclusive.
Clause 10. The catalytic structure of any clause or example herein, in particular, any one of Clauses 1-9, wherein the homogeneous mixture of each HEA nanoparticle is at least four elements selected from the group consisting of transition metals, lanthanoids, actinoids, and post-transition metals.
Clause 11. The catalytic structure of any clause or example herein, in particular, any one of Clauses 1-10, wherein the single-phase solid-solution comprises a face-centered cubic phase.
Clause 12. The catalytic structure of any clause or example herein, in particular, any one of Clauses 1-11, wherein each HEA nanoparticle has at least five different elements.
Clause 13. The catalytic structure of any clause or example herein, in particular, any one of Clauses 1-12, wherein the plurality of HEA nanoparticles is effective as a catalyst for ammonia oxidation, and the homogeneous mixture in each HEA nanoparticle is a combination of platinum (Pt), palladium (Pd), rhodium (Rh), cobalt (Co), and a promoter, and the promoter is a rare-earth element.
Clause 14. The catalytic structure of any clause or example herein, in particular, any one of Clauses 1-12, wherein the plurality of HEA nanoparticles is effective as a catalyst for ammonia decomposition, and the homogeneous mixture in each HEA nanoparticle is a combination of (i) cobalt (Co), (ii) molybdenum (Mo), and (iii) at least two transition metals.
Clause 15. The catalytic structure of any clause or example herein, in particular, Clause 14, wherein the homogenous mixture in each HEA nanoparticle satisfies CoₓMo_{y}FeₐNi_{b}Cu_{c}, x+y=100−(a+b+c), 10≤ a≤20, 10≤ b≤20, and 10≤ c≤20.
Clause 16. The catalytic structure of any clause or example herein, in particular, any one of Clauses 1-2 and 5-15, wherein the substrate comprises an extruded metal oxide pellet.
Clause 17. The catalytic structure of any clause or example herein, in particular, Clause 16, wherein the extruded metal oxide pellet is a multi-lobe cylindrical pellet having a maximum cross-sectional dimension less than or equal to 20 mm.
Clause 18. The catalytic structure of any clause or example herein, in particular, any one of Clauses 1-17, wherein the substrate comprises a powder particle having a maximum cross-sectional dimension less than or equal to 1 mm.
Clause 19. The catalytic structure of any clause or example herein, in particular, any one of Clauses 1, wherein the substrate has a plurality of pores, each pore having a diameter less than or equal to 50 nm, and/or the substrate has a pore volume in a range of 0.6 mL/g to 0.8 mL/g, inclusive.
Clause 20. The catalytic structure of any clause or example herein, in particular, any one of Clauses 1-19, wherein each HEA nanoparticle has a truncated spherical shape.
Clause 21. The catalytic structure of any clause or example, herein, in particular, any one of Clauses 1-20, further comprising a plurality of non-HEA nanoparticles formed on the surface layer of the substrate between the HEA nanoparticles.
Clause 22. The catalytic structure of any clause or example, herein, in particular, Clause 21, wherein a number of the HEA nanoparticles on the substrate is less than a number of the non-HEA nanoparticles on the substrate.
Clause 23. The catalytic structure of any clause or example, herein, in particular, any one of Clauses 1-22, wherein the plurality of HEA nanoparticles are dispersed in a gradient across a cross-section of the substrate.
Clause 24. The catalytic structure of any clause or example, herein, in particular, Clause 23, wherein the gradient is such that a particle density of the HEA nanoparticles at an exterior portion of the substrate is greater than that at an internal portion of the substrate.
Clause 25. The catalytic structure of any clause or example, herein, in particular, Clause 24, wherein the particle density at the internal portion of the substrate is in a range of 0-80%, inclusive, of the particle density at the exterior portion of the substrate.
Clause 26. A method comprising:
   providing one or more catalytic structures, each catalytic structure comprising a substrate and a plurality of high-entropy alloy (HEA) nanoparticles, at least a surface layer of the substrate being formed of a non-conductive metal oxide, the plurality of HEA nanoparticles being formed on the surface layer of the substrate, each HEA nanoparticle having a maximum cross-sectional dimension less than or equal to 1 μm, each HEA nanoparticle comprising a homogeneous mixture of at least four elements forming a single-phase solid-solution alloy; and
   flowing one or more reactants into contact with the one or more catalytic substrates such that a chemical reaction converts the one or more reactants at a first temperature to one or more products.
Clause 27. The method of any clause or example herein, in particular, Clause 26, wherein the chemical reaction comprises an oxidation reaction, a synthesis reaction, or a decomposition reaction.
Clause 28. The method of any clause or example herein, in particular, any one of Clauses 26-27, wherein:
   the one or more reactants comprise ammonia, oxygen, and nitrogen;
   the chemical reaction comprises ammonia oxidation; and
   the one or more products comprise NOₓ products.
Clause 29. The method of any clause or example herein, in particular, Clause 28, wherein the homogeneous mixture in each HEA nanoparticle is a combination of platinum (Pt), palladium (Pd), rhodium (Rh), cobalt (Co), and a promoter, the promoter being a rare-earth element.
Clause 30. The method of any clause or example herein, in particular, any one of Clauses 28-29, wherein:
   at least 90% of the one or more products are NOₓ products;
   at least 95% of the ammonia is converted to the one or more products;
   less than or equal to 1% of the one or more products is N₂O;
   the first temperature is less than or equal to 800° C.; or
   any combination of the above.
Clause 31. The method of any clause or example herein, in particular, any one of Clauses 28-30, wherein the ammonia oxidation reaction is performed without a catalyst for removing N₂O.
Clause 32. The method of any clause or example herein, in particular, any one of Clauses 26-27, wherein:
   the one or more reactants comprise hydrogen and nitrogen;
   the chemical reaction comprises ammonia synthesis; and
   the one or more products comprise ammonia.
Clause 33. The method of any clause or example herein, in particular, Clause 32, wherein the homogeneous mixture in each HEA is a combination of (i) cobalt (Co), (ii) molybdenum (Mo), and (iii) at least two transition metals (e.g., iron (Fe), nickel (Ni), and copper (Cu) or manganese (Mn)).
Clause 34. The method of any clause or example herein, in particular, any one of Clauses 32-33, wherein the first temperature is between 300° C. and 600° C., inclusive, and a mass-specific reaction rate of the chemical reaction is at least 0.7 gₐₘₘₒₙᵢₐ gₘₑₜₐₗₛ⁻¹ h⁻¹.
Clause 35. The method of any clause or example herein, in particular, any one of Clauses 32-34, wherein the first temperature is approximately 450° C., and a mass-specific reaction rate of the chemical reaction is at 1.52 gₐₘₘₒₙᵢₐ gₘₑₜₐₗₛ⁻¹ h⁻¹.
Clause 36. The method of any clause or example herein, in particular, any one of Clauses 26-35, wherein an entirety of the substrate of each catalytic structure is formed of the metal oxide.
Clause 37. The method of any clause or example herein, in particular, any one of Clauses 26-35, wherein the substrate of each catalytic structure comprises a base layer formed of a material different than the metal oxide.
Clause 38. The method of any clause or example herein, in particular, Clause 37, wherein the base layer is formed of carbon.
Clause 39. The method of any clause or example herein, in particular, any one of Clauses 26-38, wherein the maximum cross-sectional dimension of each HEA nanoparticle of each catalytic structure is less than or equal to 25 nm.
Clause 40. The method of any clause or example herein, in particular, any one of Clauses 26-39, wherein the maximum cross-sectional dimension of each HEA nanoparticle of each catalytic structure is in a range of 1-20 nm, inclusive.
Clause 41. The method of any clause or example herein, in particular, any one of Clauses 26-40, wherein the metal oxide of each catalytic structure comprises aluminum oxide, titanium oxide, cerium oxide, silicon oxide, zeolite, spinel, perovskite, or any combination of the foregoing.
Clause 42. The method of any clause or example herein, in particular, any one of Clauses 26-41, wherein a noble metal content of each catalytic structure is less than or equal to 30 wt %.
Clause 43. The method of any clause or example herein, in particular, any one of Clauses 26-42, wherein a noble metal content of each catalytic structure is in a range of 2-10 wt %, inclusive.
Clause 44. The method of any clause or example herein, in particular, any one of Clauses 26-43, wherein the homogeneous mixture of each HEA nanoparticle of each catalytic structure is at least four elements selected from the group consisting of transition metals, lanthanoids, actinoids, and post-transition metals.
Clause 45. The method of any clause or example herein, in particular, any one of Clauses 26-44, wherein the single-phase solid-solution of each HEA nanoparticle of each catalytic structure comprises a face-centered cubic phase.
Clause 46. The method of any clause or example herein, in particular, any one of Clauses 26-45, wherein each HEA nanoparticle of each catalytic structure has at least five different elements.
Clause 47. The method of any clause or example herein, in particular, any one of Clauses 26-36 and 39-46, wherein the substrate of each catalytic structure comprises an extruded metal oxide pellet.
Clause 48. The method of any clause or example herein, in particular, Clause 47, wherein each extruded metal oxide pellet is a multi-lobe cylindrical pellet having a maximum cross-sectional dimension less than or equal to 20 mm.
Clause 49. The method of any clause or example herein, in particular, any one of Clauses 26-48, wherein the substrate of each catalytic structure comprises a powder particle having a maximum cross-sectional dimension less than or equal to 1 mm.
Clause 50. The method of any clause or example herein, in particular, any one of Clauses 26-49, wherein, for each catalytic structure, the substrate has a plurality of pores, each pore has a diameter less than or equal to 50 nm, and/or the substrate has a pore volume of 0.6 mL/g to 0.8 mL/g, inclusive.
Clause 51. The method of any clause or example herein, in particular, any one of Clauses 26-50, wherein each HEA nanoparticle has a truncated spherical shape.
Clause 52. The method of any clause or example herein, in particular, any one of Clauses 26-51, wherein each catalytic structure further comprises a plurality of non-HEA nanoparticles formed on the surface layer of the substrate between the HEA nanoparticles.
Clause 53. The method of any clause or example herein, in particular, Clause 52, wherein, for each catalytic structure, a number of the HEA nanoparticles on the substrate is less than a number of the non-HEA nanoparticles on the substrate.
Clause 54. The method of any clause or example herein, in particular, any one of Clauses 26-53, wherein, for each catalytic structure, the plurality of HEA nanoparticles are dispersed in a gradient across a cross-section of the substrate.
Clause 55. The method of any clause or example herein, in particular, Clause 54, wherein, for each catalytic structure, the gradient is such that a particle density of the HEA nanoparticles at an exterior portion of the substrate is greater than that at an internal portion of the substrate.
Clause 56. The method of any clause or example herein, in particular, Clause 55, wherein, for each catalytic structure, the particle density at the internal portion of the substrate is in a range of 0-80%, inclusive, of the particle density at the exterior portion of the substrate.
Clause 57. A method for fabricating a catalytic structure, comprising:
   coating a substrate with a solution comprising a plurality of precursor metal salts, the plurality of precursor metal salts comprising at least four different elements, at least a surface layer of the substrate being formed of a non-conductive metal oxide;
   drying the substrate with the plurality of precursor metal salts; and
   subjecting the dried substrate to a thermal shock so as to form the catalytic structure, the thermal shock comprising exposure to a peak temperature of at least 1200 K for a duration of 1 second or less,
   wherein, after the thermal shock, the catalytic structure comprises a plurality of high-entropy alloy (HEA) nanoparticles formed on the surface layer of the substrate, each HEA nanoparticle having a maximum cross-sectional dimension less than or equal to 1 μm and comprising a homogeneous mixture of at least four different elements forming a single-phase solid-solution alloy.
Clause 58. The method of any clause or example herein, in particular, Clause 57, wherein the thermal shock further comprises a heating ramp to the peak temperature, and the heating ramp is at least 10³ K/s.
Clause 59. The method of any clause or example herein, in particular, any one of Clauses 57-58, wherein the thermal shock further comprises a cooling ramp from the peak temperature, and the cooling ramp is at least 10³ K/s.
Clause 60. The method of any clause or example herein, in particular, any one of Clauses 57-59, wherein the solution comprises an organic solvent or water.
Clause 61. The method of any clause or example herein, in particular, any one of Clauses 57-60, wherein each precursor metal salt comprises a chloride, a nitrate, or alkoxide.
Clause 62. The method of any clause or example herein, in particular, any one of Clauses 57-61, wherein the coating comprises wet impregnation or dry impregnation.
Clause 63. The method of any clause or example herein, in particular, any one of Clauses 57-62, wherein the coating comprises combining the solution and the substrate using a rotary drum mixer.
Clause 64. The method of any clause or example herein, in particular, any one of Clauses 57-63, wherein the drying comprises freeze-drying or critical point drying.
Clause 65. The method of any clause or example herein, in particular, any one of Clauses 57-64, wherein the duration of the thermal shock is less than 500 ms.
Clause 66. The method of any clause or example herein, in particular, any one of Clauses 57-65, wherein the duration of the thermal shock is less than 100 ms.
Clause 67. The method of any clause or example herein, in particular, any one of Clauses 57-66, wherein the peak temperature of the thermal shock is in a range of 1200-3000 K, inclusive.
Clause 68. The method of any clause or example herein, in particular, any one of Clauses 57-67, wherein the peak temperature of the thermal shock is in a range of 1500-2300 K, inclusive.
Clause 69. The method of any clause or example herein, in particular, any one of Clauses 57-68, further comprising, prior to the coating, performing a treatment on the substrate to improve surface wettability thereof.
Clause 70. The method of any clause or example herein, in particular, Clause 69, wherein the treatment comprises a plasma treatment or an acid treatment.
Clause 71. The method of any clause or example herein, in particular, any one of Clauses 57-70, wherein, prior to or during the coating, the substrate is heated.
Clause 72. The method of any clause or example herein, in particular, any one of Clauses 57-71, wherein an entirety of the substrate is formed of the metal oxide.
Clause 73. The method of any clause or example herein, in particular, any one of Clauses 57-71, wherein the substrate comprises a base layer formed of a material different than the metal oxide, and the method further comprises forming the metal oxide surface layer on the base layer.
Clause 74. The method of any clause or example herein, in particular, Clause 73, wherein the base layer is formed of carbon.
Clause 75. The method of any clause or example herein, in particular, any one of Clauses 73-64, further comprising, prior to forming the metal oxide surface layer, maintaining the base layer at a temperature greater than or equal to 700° C. in a carbon dioxide atmosphere for at least 1 hour, so as to create surface defects in the base layer.
Clause 76. The method of any clause or example herein, in particular, any one of Clauses 73-75, wherein the forming the metal oxide surface layer comprises atomic layer deposition. Clause 77. The method of any clause or example herein, in particular, any one of Clauses 73-76, wherein a thickness of the metal oxide surface layer is less than or equal to 100 nm.
Clause 78. The method of any clause or example herein, in particular, any one of Clauses 57-77, wherein the maximum cross-sectional dimension of each HEA nanoparticle is less than or equal to 25 nm.
Clause 79. The method of any clause or example herein, in particular, any one of Clauses 57-78, wherein the maximum cross-sectional dimension of each HEA nanoparticle is in a range of 1-20 nm, inclusive.
Clause 80. The method of any clause or example herein, in particular, any one of Clauses 57-79, wherein the metal oxide comprises aluminum oxide, titanium oxide, cerium oxide, silicon oxide, zeolite, spinel, perovskite, or any combination of the foregoing.
Clause 81. The method of any clause or example herein, in particular, any one of Clauses 57-80, wherein a noble metal content of the catalytic structure is less than or equal to 30 wt %.
Clause 82. The method of any clause or example herein, in particular, any one of Clauses 57-81, wherein a noble metal content of the catalytic structure is in a range of 2-10 wt %, inclusive.
Clause 83. The method of any clause or example herein, in particular, any one of Clauses 57-82, wherein the homogeneous mixture of each HEA nanoparticle is at least four elements selected from the group consisting of transition metals, lanthanoids, actinoids, and post-transition metals.
Clause 84. The method of any clause or example herein, in particular, any one of Clauses 57-83, wherein the single-phase solid-solution comprises a face-centered cubic phase.
Clause 85. The method of any clause or example herein, in particular, any one of Clauses 57-84, wherein each HEA nanoparticle comprises at least five different elements.
Clause 86. The method of any clause or example herein, in particular, any one of Clauses 57-72 and 78-85, wherein the substrate comprises an extruded metal oxide pellet.
Clause 87. The method of any clause or example herein, in particular, Clause 86, wherein the extruded metal oxide pellet is a multi-lobe cylindrical pellet having a maximum cross-sectional dimension less than or equal to 20 mm.
Clause 88. The method of any clause or example herein, in particular, any one of Clauses 57-87, further comprising:
   (a) after coating the substrate and before the thermal shock, grinding the substrate into powder particles, each having a maximum cross-sectional dimension less than or equal to 1 mm;
   (b) prior to the coating, heating the substrate at a temperature in a range of 100-200° C. so as to remove moisture from the substrate;
   (c) prior to the coating, heating the substrate at a temperature in a range of 800-1500° C. in an inert gas environment so as to increase a crystallinity of the substrate;
   (d) the coating is such that a loading of at least one of the precursor salts for a first metal is greater than a loading of the first metal in the HEA nanoparticle formed by the thermal shock, at least some of the first metal being lost during the thermal shock; or any combination of (a)-(d).
Clause 89. The method of any clause or example herein, in particular, any one of Clauses 57-88, wherein the substrate has a plurality of pores with a diameter less than or equal to 50 nm and/or the substrate has a pore volume in a range of 0.6-0.8 mL/g, inclusive.
Clause 90. The method of any clause or example herein, in particular, any one of Clauses 57-89, wherein each HEA nanoparticle has a truncated spherical shape.
Clause 91. The method of any clause or example herein, in particular, any one of Clauses 57-90, wherein, after the thermal shock, the catalytic structure further comprises a plurality of non-HEA nanoparticles formed on the surface layer of the substrate between the HEA nanoparticles.
Clause 92. The method of any clause or example herein, in particular, Clause 91, wherein, after the thermal shock, a number of the HEA nanoparticles on the substrate is less than a number of the non-HEA nanoparticles on the substrate.
Clause 93. The method of any clause or example herein, in particular, any one of Clauses 57-92, wherein, after the thermal shock, the plurality of HEA nanoparticles are dispersed in a gradient across a cross-section of the substrate.
Clause 94. The method of any clause or example herein, in particular, Clause 93, wherein the gradient is such that a particle density of the HEA nanoparticles at an exterior portion of the substrate is greater than that at an internal portion of the substrate.
Clause 95. The method of any clause or example herein, in particular, Clause 94, wherein the particle density at the internal portion of the substrate is in a range of 0-80%, inclusive, of the particle density at the exterior portion of the substrate.
Clause 96. A method comprising:
   removing a Pt-based catalyst and an N₂O-removal catalyst from a nitric acid production reactor, the nitric acid production reactor having (i) one or more inlets for ammonia, oxygen, and nitrogen, and (ii) one or more outlets for NOₓ products, the Pt-based catalyst being at a first location between the one or more inlets and one or more outlets prior to the removing, the N₂O-removal catalyst being at a second location downstream of the first location prior to the removing; and
   installing one or more catalytic structures within the nitric acid production reactor, each catalytic structure comprising a substrate and a plurality of high-entropy alloy (HEA) nanoparticles, at least a surface layer of the substrate being formed of a non-conductive metal oxide, the plurality of HEA nanoparticles being formed on the surface layer of the substrate, each HEA nanoparticle having a maximum cross-sectional dimension less than or equal to 1 μm, each HEA nanoparticle comprising a homogeneous mixture of at least four elements forming a single-phase solid-solution alloy.
Clause 97. The method of any clause or example herein, in particular, Clause 96, further comprising:
   flowing, via the one or more inlets, ammonia, oxygen, and nitrogen into contact with the one or more catalytic structures in the nitric acid production reactor such that ammonia, oxygen, and nitrogen are converted into NOₓ products,
   wherein the nitric acid production reactor operates without a N₂O removal catalyst.
Clause 98. The method of any clause or example herein, in particular, any one of Clauses 96-97, wherein the nitric acid production reactor comprises a pancake reactor.
Clause 99. The method of any clause or example herein, in particular, any one of Clauses 96-98, wherein:
   (a) the Pt-based catalyst is a PtRh gauze catalyst;
   (b) the homogeneous mixture in each HEA nanoparticle is a combination of platinum (Pt), palladium (Pd), rhodium (Rh), cobalt (Co), and a promoter, the promoter being a rare-earth element; or
   (c) both (a) and (b).
Clause 100. The method of any clause or example herein, in particular, any one of Clauses 96-99, wherein an entirety of the substrate is formed of the metal oxide.
Clause 101. The method of any clause or example herein, in particular, any one of Clauses 96-99, wherein the substrate comprises a base layer formed of a material different than the metal oxide.
Clause 102. The method of any clause or example herein, in particular, Clause 101, wherein the base layer is formed of carbon.
Clause 103. The method of any clause or example herein, in particular, any one of Clauses 96-102, wherein the maximum cross-sectional dimension of each HEA nanoparticle is less than or equal to 25 nm.
Clause 104. The method of any clause or example herein, in particular, any one of Clauses 96-103, wherein the maximum cross-sectional dimension of each HEA nanoparticle is in a range of 1-20 nm, inclusive.
Clause 105. The method of any clause or example herein, in particular, any one of Clauses 96-104, wherein the metal oxide comprises aluminum oxide, titanium oxide, cerium oxide, silicon oxide, zeolite, spinel, perovskite, or any combination of the foregoing.
Clause 106. The method of any clause or example herein, in particular, any one of Clauses 96-105, wherein a noble metal content of the catalytic structure is less than or equal to 30 wt %.
Clause 107. The method of any clause or example herein, in particular, any one of Clauses 96-106, wherein a noble metal content of the catalytic structure is in a range of 2-10 wt %, inclusive.
Clause 108. The method of any clause or example herein, in particular, any one of Clauses 96-107, wherein the homogeneous mixture of each HEA nanoparticle is at least four elements selected from the group consisting of transition metals, lanthanoids, actinoids, and post-transition metals.
Clause 109. The method of any clause or example herein, in particular, any one of Clauses 96-108, wherein the single-phase solid-solution comprises a face-centered cubic phase.
Clause 110. The method of any clause or example herein, in particular, any one of Clauses 96-109, wherein each HEA nanoparticle comprises at least five different elements.
Clause 111. The method of any clause or example herein, in particular, any one of Clauses 96-99 and 103-110, wherein the substrate comprises an extruded metal oxide pellet.
Clause 112. The method of any clause or example herein, in particular, Clause 111, wherein the extruded metal oxide pellet is a multi-lobe cylindrical pellet having a maximum cross-sectional dimension less than or equal to 20 mm.
Clause 113. The method of any clause or example herein, in particular, any one of Clauses 96-112, wherein the substrate comprises a powder particle having a maximum cross-sectional dimension less than or equal to 1 mm.
Clause 114. The method of any clause or example herein, in particular, any one of Clauses 96-113, wherein the one or more catalytic structures are installed at the second location in the nitric acid production reactor.
Clause 115. The method of any clause or example herein, in particular, any one of Clauses 96-114, wherein the substrate of each catalytic structure has pores having a diameter less than or equal to 50 nm and/or a pore volume in a range of 0.6 mL/g to 0.8 mL/g.
Clause 116. The method of any clause or example herein, in particular, any one of Clauses 96-115, wherein, for each catalytic structure, each HEA nanoparticle has a truncated spherical shape.
Clause 117. The method of any clause or example herein, in particular, any one of Clauses 96-116, wherein each catalytic structure further comprises a plurality of non-HEA nanoparticles formed on the surface layer of the substrate between the HEA nanoparticles.
Clause 118. The method of any clause or example herein, in particular, Clause 117, wherein, for each catalytic structure, a number of the HEA nanoparticles on the substrate is less than a number of the non-HEA nanoparticles on the substrate.
Clause 119. The method of any clause or example herein, in particular, any one of Clauses 96-118, wherein, for each catalytic structure, the plurality of HEA nanoparticles are dispersed in a gradient across a cross-section of the substrate.
Clause 120. The method of any clause or example herein, in particular, Clause 119, wherein, for each catalytic structure, the gradient is such that a particle density of the HEA nanoparticles at an exterior portion of the substrate is greater than that at an internal portion of the substrate.
Clause 121. The method of any clause or example herein, in particular, Clause 120, wherein, for each catalytic structure, the particle density at the internal portion of the substrate is in a range of 0-80%, inclusive, of the particle density at the exterior portion of the substrate.

### CONCLUSION

Any of the features illustrated or described herein, for example, with respect to FIGS. 1A-9C and Clauses 1-121, can be combined with any other feature illustrated or described herein, for example, with respect to FIGS. 1A-9C and Clauses 1-121 to provide materials, systems, devices, structures, methods, and embodiments not otherwise illustrated or specifically described herein. All features described herein are independent of one another and, except where structurally impossible, can be used in combination with any other feature described herein. In view of the many possible embodiments to which the principles of the disclosed technology may be applied, it should be recognized that the illustrated embodiments are only examples and should not be taken as limiting the scope of the disclosed technology. Rather, the scope is defined by the following claims. We therefore claim all that comes within the scope and spirit of these claims.

1. A catalytic structure comprising:
a substrate, at least a surface layer of the substrate being formed of a metal oxide; and
a plurality of high-entropy alloy (HEA) nanoparticles formed on the surface layer of the substrate, each HEA nanoparticle having a maximum cross-sectional dimension less than or equal to 1 μm, each HEA nanoparticle comprising a homogeneous mixture of at least four different elements forming a single-phase solid-solution alloy.

2. The catalytic structure of claim 1, wherein an entirety of the substrate is formed of the metal oxide.

3. The catalytic structure of claim 1, wherein:
the substrate comprises a base layer formed of a material different than the metal oxide; and
the base layer is formed of carbon.

4-8. (canceled)

9. The catalytic structure of claim 1, wherein a noble metal content of the catalytic structure is in a range of 2-10 wt %, inclusive.

10. (canceled)

11. The catalytic structure of claim 1, wherein the single-phase solid-solution comprises a face-centered cubic phase.

12. (canceled)

13. The catalytic structure of claim 1, wherein:
the plurality of HEA nanoparticles is effective as a catalyst for ammonia oxidation,
the homogeneous mixture in each HEA nanoparticle is a combination of platinum (Pt), palladium (Pd), rhodium (Rh), cobalt (Co), and a promoter, and
the promoter is a rare-earth element.

14. The catalytic structure of claim 1, wherein the plurality of HEA nanoparticles is effective as a catalyst for ammonia decomposition, and the homogeneous mixture in each HEA nanoparticle is a combination of (i) cobalt (Co), (ii) molybdenum (Mo), and (iii) at least two transition metals.

15. The catalytic structure of claim 14, wherein:
the homogenous mixture in each HEA nanoparticle satisfies CoₓMo_{y}FeₐNi_{b}Cu_{c};
$$x + y = 100 - ( a + b + c ) ; \\ 10 \leq a \leq 20 ; \\ 10 \leq b \leq 20 ; and \\ 10 \leq c \leq 20.$$

16. The catalytic structure of claim 1, wherein the substrate comprises an extruded metal oxide pellet.

17-20. (canceled)

21. The catalytic structure of claim 1, further comprising a plurality of non-HEA nanoparticles formed on the surface layer of the substrate between the HEA nanoparticles.

22. The catalytic structure of claim 21, wherein a number of the HEA nanoparticles on the substrate is less than a number of the non-HEA nanoparticles on the substrate.

23. The catalytic structure of claim 1, wherein the plurality of HEA nanoparticles are dispersed in a gradient across a cross-section of the substrate.

24. The catalytic structure of claim 23, wherein the gradient is such that a particle density of the HEA nanoparticles at an exterior portion of the substrate is greater than that at an internal portion of the substrate.

25. (canceled)

26. A method comprising:
providing one or more catalytic structures, each catalytic structure comprising a substrate and a plurality of high-entropy alloy (HEA) nanoparticles, at least a surface layer of the substrate being formed of a metal oxide, the plurality of HEA nanoparticles being formed on the surface layer of the substrate, each HEA nanoparticle having a maximum cross-sectional dimension less than or equal to 1 μm, each HEA nanoparticle comprising a homogeneous mixture of at least four elements forming a single-phase solid-solution alloy; and
flowing one or more reactants into contact with the one or more catalytic substrates such that a chemical reaction converts the one or more reactants at a first temperature to one or more products.

27. The method of claim 26, wherein the chemical reaction comprises an oxidation reaction, a synthesis reaction, or a decomposition reaction.

28. The method of claim 26, wherein:
the one or more reactants comprise ammonia, oxygen, and nitrogen;
the chemical reaction comprises ammonia oxidation; and
the one or more products comprise NOₓ products.

29. (canceled)

30. The method of claim 28, wherein:
at least 90% of the one or more products are NOₓ products;
at least 95% of the ammonia is converted to the one or more products;
less than or equal to 1% of the one or more products is N₂O;
the first temperature is less than or equal to 800° C.; or
any combination of the above.

31. The method of claim 28, wherein the ammonia oxidation reaction is performed without a catalyst for removing N₂O.

32. The method of claim 26, wherein:
the one or more reactants comprise hydrogen and nitrogen;
the chemical reaction comprises ammonia synthesis; and
the one or more products comprise ammonia.

33. The method of claim 32, wherein the homogeneous mixture in each HEA is a combination of (i) cobalt (Co), (ii) molybdenum (Mo), and (iii) at least two transition metals.

34. The method of claim 32, wherein the first temperature is between 300° C. and 600° C., inclusive, and a mass-specific reaction rate of the chemical reaction is at least 0.7 gₐₘₘₒₙᵢₐ gₘₑₜₐₗₛ⁻¹ h⁻¹.

35-56. (canceled)
